(19) United States
(12) Patent Application Publication
(10) Pub. No.: US 2022/0351425 A1
(43) Pub. Date: Nov. 3, 2022

(54) INTEGRATING OVERLAID DIGITAL CONTENT INTO DATA VIA PROCESSING CIRCUITRY USING AN AUDIO BUFFER

(71) Applicant: MOBEUS INDUSTRIES, INC., Sparta, NJ (US)

(72) Inventors: Dharmendra ETWARU, Sparta, NJ (US); Michael R. SUTCLIFF, Inlet Beach, FL (US)

(73) Assignee: MOBEUS INDUSTRIES, INC., Sparta, NJ (US)

(21) Appl. No.: 17/675,718

(22) Filed: Feb. 18, 2022

Related U.S. Application Data
(60) Provisional application No. 63/188,256, filed on May 13, 2021.
(60) Provisional application No. 63/182,391, filed on Apr. 30, 2021.

(51) Int. Cl. G06T 11/00; G10L 25/18; G10L 25/51; G10L 19/018; H04M 1/72484

(52) U.S. Cl. CPC G06T 11/00; G10L 25/18; G10L 25/51; G10L 19/018; H04M 1/72484

(57) ABSTRACT

The present disclosure is related to a method, including receiving, by processing circuitry, data transmitted over a communication network during a voice call, accessing an audio buffer of the processing circuitry, analyzing, in the audio buffer of the processing circuitry, audio data associated with the transmitted data, based on the analyzed audio data in the audio buffer, identifying an audio reference patch that includes a unique identifier associated with an available area in which secondary digital content located at a remote device is insertable in displayed data that is being displayed by the processing circuitry during the voice call, after identifying the audio reference patch, retrieving the secondary digital content from the remote device based on the unique identifier, and after retrieving the secondary digital content from the remote device, overlaying the secondary digital content into the displayed data during the voice call.

### CROSS-REFERENCE TO RELATED APPLICATIONS

The present application claims priority to U.S. Provisional Application No. 63/188,256, filed May 13, 2021, and U.S. Provisional Application No. 63/182,391, filed Apr. 30, 2021, the entire content of each of which is incorporated by reference herein in its entirety for all purposes.

### BACKGROUND

### Field of the Disclosure

The present disclosure relates to generating an augmentation of a user visual experience.

### Description of the Related Art

Voice calling, by one definition, is the ability to contact and converse with people in real-time using a telephone. In the context of smartphones, voice calling can include a user interface that allows the user to control certain features associated with the communication between people. For instance, the user interface of the smartphone may allow the user to temporarily turn the microphone off, control a volume of a speaker that projects audio coming from the other call participant, end the call, and the like. Certain products allow the user to transition from a purely voice call to a video call. This transition often requires initializing and migrating to a separate application in order to capture both the audio data and the video data.

As a result, voice calling is traditionally constrained in what functionalities may be offered during the user experience.

The foregoing “Background” description is for the purpose of generally presenting the context of the disclosure. Work of the inventors, to the extent it is described in this background section, as well as aspects of the description which may not otherwise qualify as prior art at the time of filing, are neither expressly or impliedly admitted as prior art against the present disclosure.

### SUMMARY

The present disclosure relates to electronic device, including: processing circuitry, including an audio buffer, configured to receive data transmitted over a communication network during a voice call, access an audio buffer of the processing circuitry, analyze, in the audio buffer, audio data associated with the transmitted data, based on the analyzed audio data in the audio buffer, identify an audio reference patch that includes a unique identifier associated with an available area in which secondary digital content located at a remote device is insertable in displayed data that is being displayed by the processing circuitry during the voice call, after identifying the audio reference patch, retrieve the secondary digital content from the remote device based on the unique identifier, and after retrieving the secondary digital content from the remote device, overlay the secondary digital content into the displayed data during the voice call.

The present disclosure also relates to a method, including: receiving, by processing circuitry, data transmitted over a communication network during a voice call; accessing an audio buffer of the processing circuitry; analyzing, in the audio buffer of the processing circuitry, audio data associated with the transmitted data; based on the analyzed audio data in the audio buffer, identifying an audio reference patch that includes a unique identifier associated with an available area in which secondary digital content located at a remote device is insertable in displayed data that is being displayed by the processing circuitry during the voice call; after identifying the audio reference patch, retrieving the secondary digital content from the remote device based on the unique identifier; and after retrieving the secondary digital content from the remote device, overlaying the secondary digital content into the displayed data during the voice call.

The present disclosure also relates to a non-transitory computer-readable storage medium storing computer-readable instructions that, when executed by a computer, cause the computer to perform a method, including: receiving, by processing circuitry, data transmitted over a communication network during a voice call; accessing an audio buffer of the processing circuitry; analyzing, in the audio buffer of the processing circuitry, audio data associated with the transmitted data; based on the analyzed audio data in the audio buffer, identifying an audio reference patch that includes a unique identifier associated with an available area in which secondary digital content located at a remote device is insertable in displayed data that is being displayed by the processing circuitry during the voice call; after identifying the audio reference patch, retrieving the secondary digital content from the remote device based on the unique identifier; and after retrieving the secondary digital content from the remote device, overlaying the secondary digital content into the displayed data during the voice call.

The foregoing paragraphs have been provided by way of general introduction and are not intended to limit the scope of the following claims. The described embodiments, together with further advantages, will be best understood by reference to the following detailed description taken in conjunction with the accompanying drawings.

### BRIEF DESCRIPTION OF THE DRAWINGS

A more complete appreciation of the disclosure and many of the attendant advantages thereof will be readily obtained as the same becomes better understood by reference to the following detailed description when considered in connection with the accompanying drawings, wherein:

FIG. 1 is a schematic view of user devices communicatively connected to a server, according to an exemplary embodiment of the present disclosure.

FIG. 2A is a flow chart for a method of generating a reference patch and embedding the reference patch into displayed data, according to an exemplary embodiment of the present disclosure.

FIG. 2B is a flow chart of a sub-method of generating the reference patch, according to an exemplary embodiment of the present disclosure.

FIG. 2C is a flow chart of a sub-method of associating the surface area with digital content, according to an exemplary embodiment of the present disclosure.

FIG. 2D is a flow chart of a sub-method of integrating the reference patch into the displayed data, according to an exemplary embodiment of the present disclosure.

FIG. 3A is an illustration of a display, according to an exemplary embodiment of the present disclosure.

FIG. 3B is an illustration of a reference patch within a frame of a display, according to an exemplary embodiment of the present disclosure.

FIG. 3C is an illustration of an augmentation within a frame of a display, according to an exemplary embodiment of the present disclosure.

FIG. 4 is a flow diagram of a method, according to an exemplary embodiment of the present disclosure.

FIG. 5A is an illustration of a smartphone having a display, according to an exemplary embodiment of the present disclosure.

FIG. 5B is an illustration of an implementation of a method, according to an exemplary embodiment of the present disclosure.

FIG. 5C is an illustration of an implementation of a method, according to an exemplary embodiment of the present disclosure.

FIG. 5D is an illustration of an implementation of a method, according to an exemplary embodiment of the present disclosure.

FIG. 5E is an illustration of an implementation of a method, according to an exemplary embodiment of the present disclosure.

FIG. 5F is an illustration of an implementation of a method, according to an exemplary embodiment of the present disclosure.

FIG. 5G is an illustration of an implementation of a method, according to an exemplary embodiment of the present disclosure.

FIG. 5H is an illustration of an implementation of a method, according to an exemplary embodiment of the present disclosure.

FIG. 5I is an illustration of an implementation of a method, according to an exemplary embodiment of the present disclosure.

FIG. 5J is an illustration of an implementation of a method, according to an exemplary embodiment of the present disclosure

FIG. 5K is an illustration of an implementation of a method, according to an exemplary embodiment of the present disclosure.

FIG. 5L is an illustration of an implementation of a method, according to an exemplary embodiment of the present disclosure.

FIG. 6 is a schematic of hardware of a user device for performing a method, according to an exemplary embodiment of the present disclosure.

FIG. 7 is a schematic of a hardware system for performing a method, according to an exemplary embodiment of the present disclosure.

FIG. 8 is a schematic of a hardware configuration of a device for performing a method, according to an exemplary embodiment of the present disclosure.

FIG. 9 is an example of Transparent Computing.

### DETAILED DESCRIPTION

The terms “a” or “an”, as used herein, are defined as one or more than one. The term “plurality”, as used herein, is defined as two or more than two. The term “another”, as used herein, is defined as at least a second or more. The terms “including” and/or “having”, as used herein, are defined as comprising (i.e., open language). Reference throughout this document to “one embodiment”, “certain embodiments”, “an embodiment”, “an implementation”, “an example” or similar terms means that a particular feature, structure, or characteristic described in connection with the embodiment is included in at least one embodiment of the present disclosure. Thus, the appearances of such phrases or in various places throughout this specification are not necessarily all referring to the same embodiment. Furthermore, the particular features, structures, or characteristics may be combined in any suitable manner in one or more embodiments without limitation.

The present disclosure provides methods for generating augmented voice calling experiences that integrate a variety of sensory experiences. According to an embodiment, the present disclosure relates to augmentation of a digital user experience. The augmentation may include an overlaying of digital objects onto a viewable display area of a display. The display may be a display of a mobile device such as a smartphone, tablet, and the like, a display of a desktop computer, or another interactive display. The digital objects may include text, images, videos, and other graphical elements, among others. The digital objects may be interactive. The digital objects may be associated with third-party software vendors.

In order to realize the augmentation of a digital user experience, a reference patch, that is a region of interest acting as an anchor, can be used. In one embodiment, the reference patch or other visually detectable element may serve to indicate a position at which digital content is to be placed onto a display. In some embodiments and as described herein, the reference patch may include encoded information that may be used to retrieve digital content and place that digital content into a desired location or locations in displayed data. The reference patch can be embedded within displayed data (such as, but not limited to, an image, a video, a document, a webpage, or any other application that may be displayed by an electronic device). The reference patch can include unique identifying data, a marker, or encoding corresponding to predetermined digital content. The reference patch can indicate to the electronic device the particular content that is to be displayed, the position at which the content is to be placed, and the size with which the content is to be displayed. Accordingly, when a portion of the displayed data including the reference patch is visible in a current frame of displayed data, the corresponding augmentation can be overlaid on the current frame of the displayed data wherein the augmentation includes secondary digital content (i.e., content that is secondary to (or comes after) the primary displayed data), herein referred to as “digital content,” and/or digital objects. For example, an augmentation can include additional images to be displayed with the current frame of displayed data for a seamless visual experience.

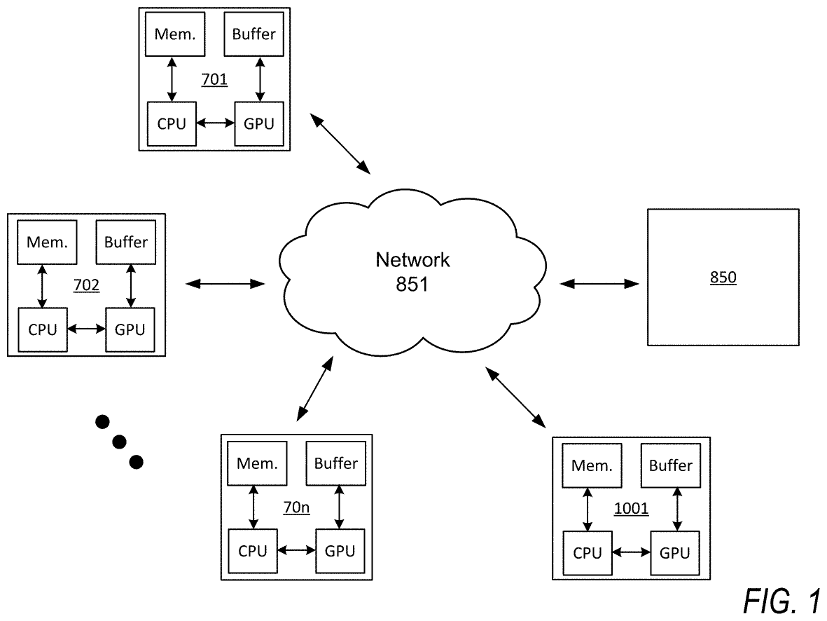

Referring now to the figures, FIG. 1 is a schematic view of an electronic device, such as a client/user device (a first device 701) communicatively connected, via a network 851, to a second electronic device, such as a server (a second device 850), and a generating device 1001, according to an embodiment of the present disclosure. Further, in an embodiment, additional client/user devices can be communicatively connected to both the first device 701 and the second device 850. A second client/user device (a third device 702) can be communicatively connected to the first device 701 and the second device 850. As shown, a plurality of the client/user devices can be communicatively connected to, for example, an Nth user device 70n.

An application may be installed or accessible on the first device 701 for executing the methods described herein. The application may also be integrated into the operating system (OS) of the first device 701. The first device 701 can be any electronic device such as, but not limited to, a personal computer, a tablet pc, a smart-phone, a smart-watch, an integrated AR/VR (Augmented Reality/Virtual Reality) headwear with the necessary computing and computer vision components installed (e.g., a central processing unit (CPU), a graphics processing unit (GPU), integrated graphics on the CPU, etc.), a smart-television, an interactive screen, a smart projector or a projected platform, an IoT (Internet of things) device or the like.

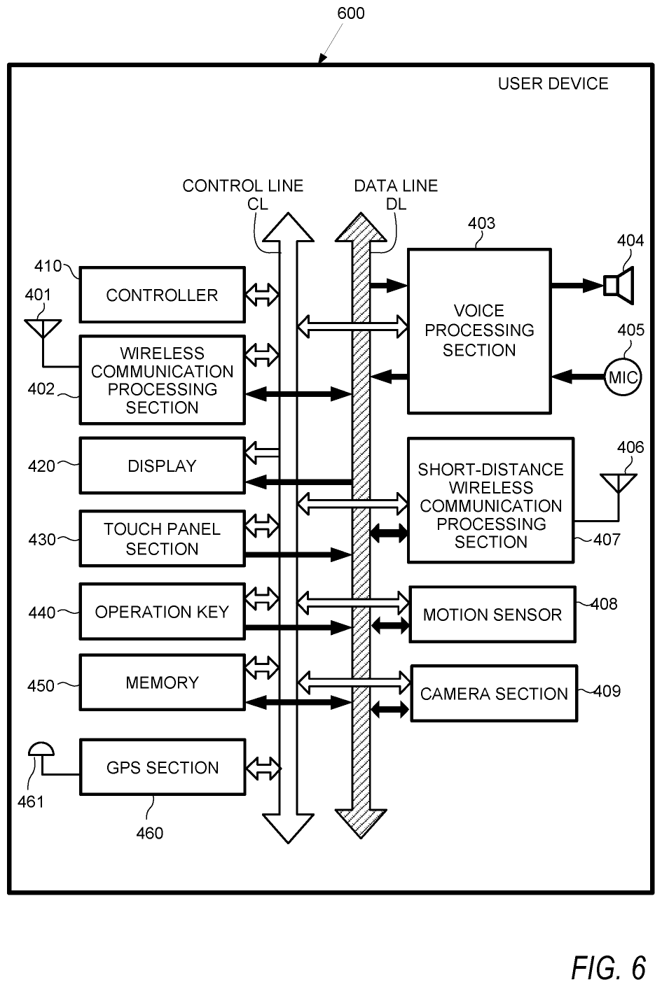

As illustrated in FIG. 1, the first device 701 includes a CPU, a GPU, a main memory, and a buffer (frame buffer, audio buffer, etc.), among other components (discussed in more detail in FIGS. 6-8). In an embodiment, the first device 701 can call graphics that are displayed on a display. The graphics of the first device 701 can be processed by the GPU and rendered in scenes stored on the buffer, such as a frame buffer, that is coupled to the display. In an embodiment, the first device 701 can run software applications or programs that are displayed on a display. In order for the software applications to be executed by the CPU, they can be loaded into the main memory, which can be faster than a secondary storage, such as a hard disk drive or a solid state drive, in terms of access time. The main memory can be, for example, random access memory (RAM) and is physical memory that is the primary internal memory for the first device 701. The CPU can have an associated CPU memory and the GPU can have an associated video or GPU memory. The frame buffer may be an allocated area of the video memory. The GPU can display the data pertaining to the software applications. It can be understood that the CPU may have multiple cores or may itself be one of multiple processing cores in the first device 701. The CPU can execute commands in a CPU programming language such as C++. The GPU can execute commands in a GPU programming language such as HLSL. The GPU may also include multiple cores that are specialized for graphic processing tasks. Although the above description was discussed with respect to the first device 701, it is to be understood that the same description applies to the other devices (701, 702, 70n, and 1001) of FIG. 1. Although not illustrated in FIG. 1, the second device 850 can also include a CPU, GPU, main memory, and frame buffer.

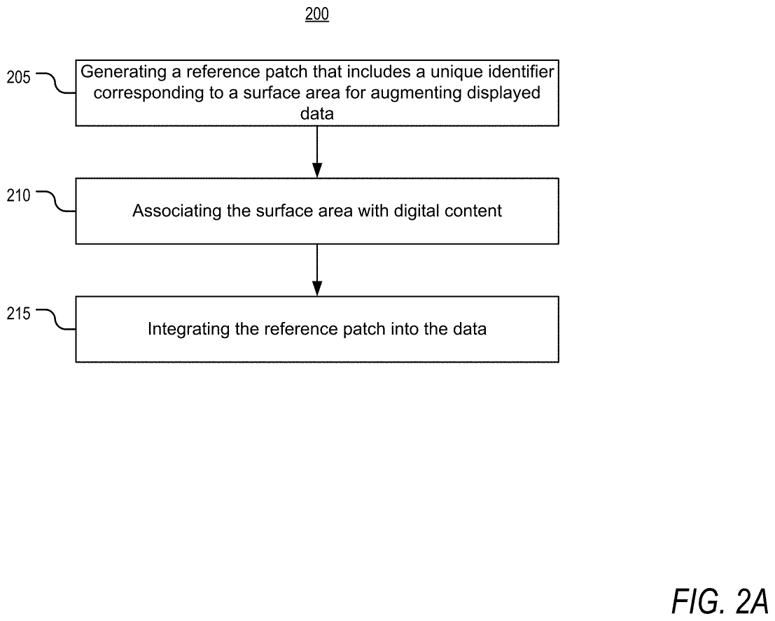

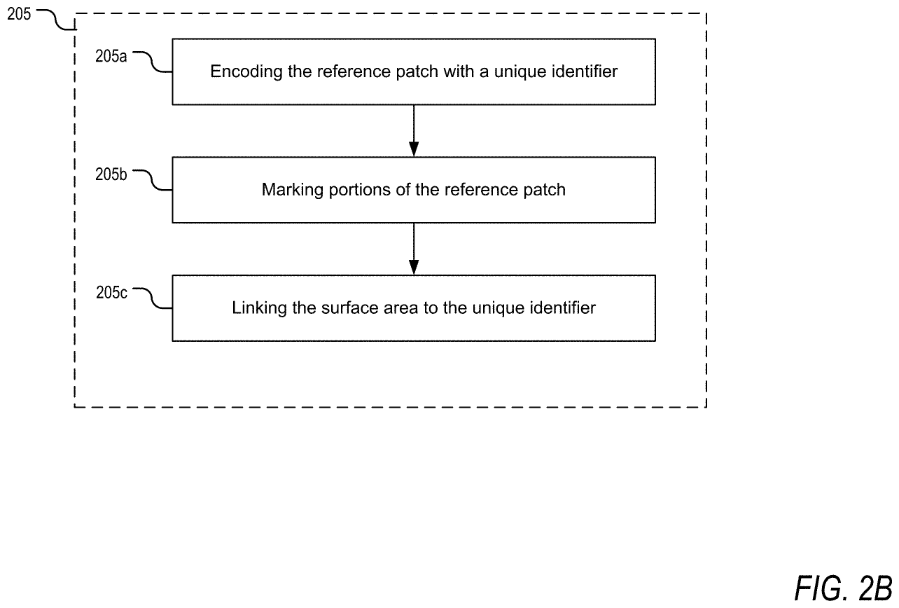

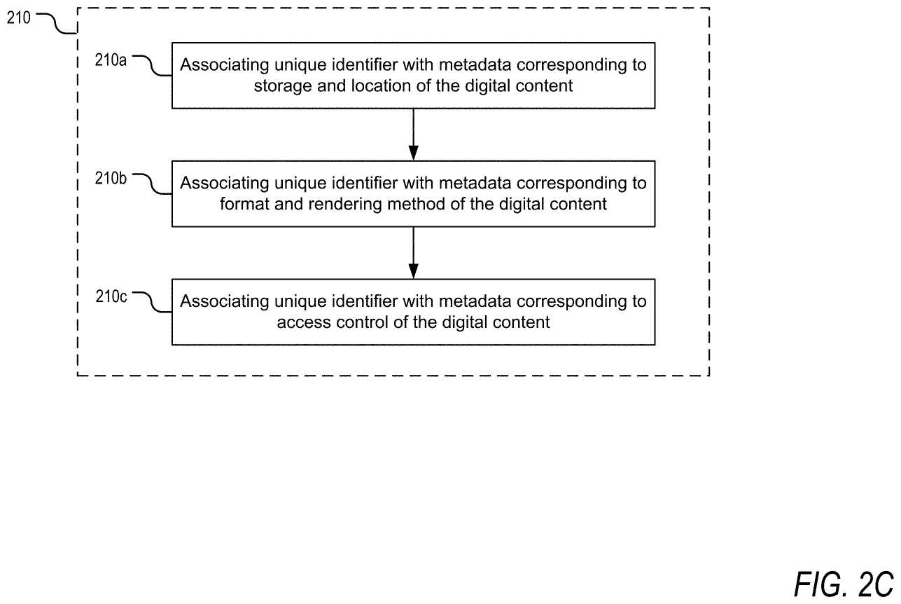

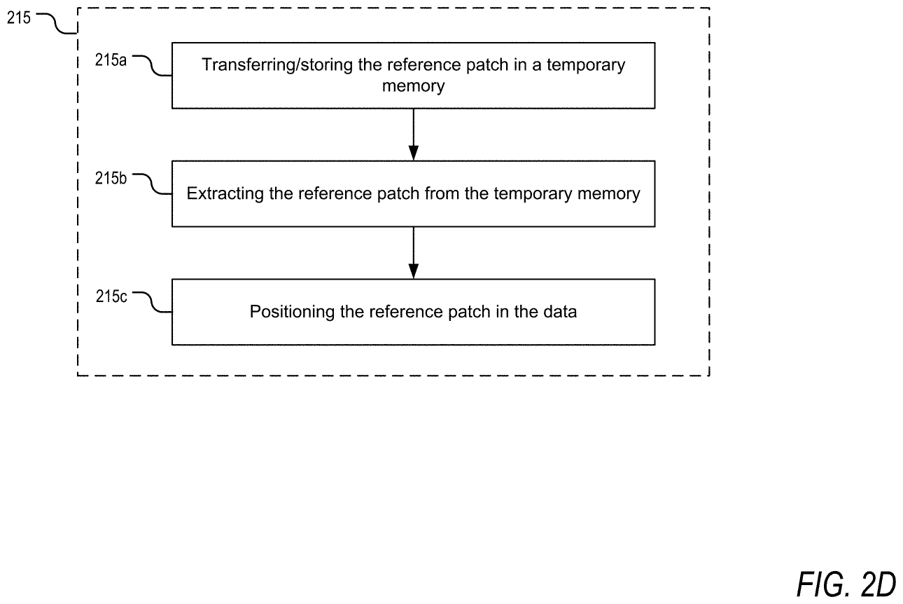

Augmentations of the digital user experience with secondary digital content can be realized through incorporation of a region of interest corresponding to the digital content, or a reference patch corresponding to the digital content, into the data. To this end, FIG. 2A is a flow chart for a method 200 of generating a reference patch and integrating the reference patch into the data, such as (visual) displayed data or embedding the reference patch into, for example, audio data as described below with regard to, for example, a user engaged on a voice call, according to an embodiment of the present disclosure. The present disclosure describes generation of the reference patch and embedding of this patch into the data content in order to integrate additional content on the first device 701. In an embodiment, the first device 701 can incorporate digital content into what is already being displayed (data) for a more immersive experience.

In this regard, the first device 701 can generate the reference patch in step 205. The reference patch can be an object having an area and shape that is embedded in the data at a predetermined location in the data. For example, the reference patch can be a square overlayed and disposed in a corner of a digital document (an example of data), wherein the reference patch can be fixed to a predetermined page for a multi-page (or multi-slide) digital document. The reference patch can thus also represent a region of interest in the digital document. The reference patch can be an object that, when not in a field of view of the user, is inactive. The reference patch can, upon entering the field of view of the user, become active. For example, the reference patch can become active when detected by the first device 701 in the data. When active, the reference patch can retrieve digital content and augment the data by incorporating the retrieved digital content into the data. Alternatively, the reference patch can become active when being initially located within the frame of the screen outputting the data. For example, even if another window or popup is placed over top of the reference patch, the reference patch may continue to be active so long as the reference patch remains in the same location after detection and the window including the document incorporating the reference patch is not minimized or closed. As will be described further below, the reference patch can have a predetermined design that can be read by the first device 701, leading to the retrieval and displaying of the digital content.

In an embodiment, the first device 701 can use a geometrical shape for the reference patch for placement into any data using applications executed in the first device 701. The reference patch can take any shape such as a circle, square, rectangle or any arbitrary shape. In step 210, the reference patch can also have predetermined areas within its shape for including predetermined data. The predetermined data can be, for example, unique identifiers that correspond to a surface area of the data. The unique identifiers can be, for example, a marker. As will be described below, the marker can take the form of patterns, shapes, pixel arrangements, pixel luma, and pixel chroma, among others. The surface area, by way of the unique identifiers, can be associated with predetermined digital content that is recalled and displayed at the corresponding surface area in the data. The unique identifier can include encoded data that identifies the digital content, a location address of the digital content at the second device 850 (see description below), a screen position within the surface area at which the digital content is insertable in the data, and a size of the digital content when inserted in the data (adjustable before being displayed).

That is, in an embodiment, the surface area (or an available area in which digital content is insertable/to be inserted) of the data can be portion(s) of the data that do not include objects that might obscure the reference patch or the digital content displayed at the corresponding surface area in the data. For example, the first device 701 can use computer vision (described below) to detect the objects. For example, the first device 701 can inspect an array to determine locations of the objects. For example, a slide in a slide deck can include text, pictures, logos, and other media, and the surface area can be the blank space or spaces around the aforementioned objects. Thus, the digital content can be displayed somewhere in the blank spaces. In an embodiment, the surface area of the data can include portions of the data that already include objects and the digital content can be displayed at the same location as the objects. For example, a slide in a slide deck can include a picture of a user, and the reference patch can be the area representing a face of the user and the digital content can be displayed at the same location as a body of the user. For example, a slide in a slide deck can include an image of a vehicle and the reference patch can be disposed in a blank space of the data, while the digital content retrieved (e.g., a new car paint color and new rims) can be displayed over the image of the vehicle. In other words, the digital content may be placed in a blank area of the data and/or in an area that is not blank (i.e., an area that includes text, image(s), video(s), etc.).

In an embodiment, for mobile devices capable of sending and receiving audio files and audio data, when the user is engaged in a voice call, the data can be audio data and the reference patch may be embedded within the audio data. The digital content may be generated on the display area of the first device 701 in response to detection of the reference patch in the audio data in real-time. In other words, the reference patch embedded in the audio data transmitted during a phone call (or voice call), can produce a visual augmentation (or generate displayed data) on the screen of the first device 701. This is described further below.

In step 215, the first device 701 can embed the reference patch into the data, such as a word processing document file (i.e., DOC/DOCX) provided by e.g., Microsoft® Word, in a Portable Document Format (PDF) file such as the ones used by Adobe Acrobat®, in a Microsoft® PowerPoint presentation (PPT/PPTX), or in a video sequence file such as MPEG, MOV, AVI or the like. These file formats are illustrative of some file types which a user may be familiar with; however, applications included in the first device 701 are not limited to these types and other applications and their associated file types are possible.

The reference patch (or similar element) can be embedded into any data, where the data may be generated by an application running on or being executed by the first device 701. The reference patch can encompass the whole area designated by the data, or just a portion of the area designated by the data. The method of generating the reference patch and embedding the reference patch into the data has been described as being performed by the first device 701, however, the second device 850 can instead perform the same functions. In order to be detected in the data on the first device 701, the reference patch may only be simply displayed as an image on the screen. The reference patch may also simply be a raster image or in the background of an image. The reference patch is also able to be read even when the image containing the reference patch is low resolution. Because the reference patch is encoded in a hardy and enduring manner such that even if a portion of the reference patch is corrupted or undecipherable, the reference patch can still be activated and used.

In an embodiment, the reference patch can be embedded inside of a body of an email correspondence. The user can use any electronic mail application such as Microsoft Outlook®, Gmail®, Yahoo®, etcetera. As the application is running on the first device 701, it allows the user to interact with other applications. In an embodiment, the reference patch can be embedded on a video streaming or two-way communication interface such as a Skype® video call or a Zoom® video call, among others. In an embodiment, the reference patch can be embedded in data for multi-party communication on a live streaming interface such as Twitch®.

One way in which the first device 701 may embed the reference patch into the data is by arranging the generated reference patch in the data such as in a desired document or other media. The reference patch may include a facade of the digital content which becomes an integrated part of the data. The facade can act as a visual preview to inform the user of the digital content linked to the reference patch. The facade can include, for example, a screenshot of a video to be played, a logo, an animation, or an image thumbnail, among others. The facade can be a design overlay. The design overlay can be a picture that represents the underlying digital content superimposed over the reference patch. In an embodiment, the facade can indicate the content that is represented by the reference patch. The facade can be contained within the shape of the reference patch or have a dynamic size. For example, attention of the user can be brought to the facade by adjusting the size of the facade when the reference patch is displayed on the display. The adjustment of the size of the facade can also be dynamic, wherein the facade can enlarge and shrink multiple times. By the same token, a position and rotation of the facade can also be adjusted to produce a shaking or spinning effect, for instance.

Unlike traditional means of sending data, the first device 701 may not send the whole digital content with a header file (metadata) and a payload (data). Instead, the reference patch that may include a facade of the underlying digital content is placed within the data. If a facade is used, it indicates to the first device 701 that the surface area can have digital content that can be accessed with selection (clicking with a mouse, touchpad, eye-gaze, eye-blinks, or via voice-command) of the facade. The digital content can also be accessed or activated automatically, e.g., when the user has the reference patch displayed on the display of the first device 701. Other symbolic means of visualization can be employed to indicate to the user that the surface area is likely to include information for obtaining digital content. For example, a highlighting effect can be applied along a perimeter of the reference patch in a pulsating pattern of highlighting intensity to bring attention to the presence of the reference patch. For example, a series of spaced dashes surrounding the reference patch and oriented perpendicular to the perimeter of the reference patch can appear and disappear to provide a flashing effect. Other means can be employed to indicate to the user that the surface area is likely to include information for obtaining digital content, such as an audio cue.

The first device 701 employs further processes before embedding the reference patch into the data. These processes and schemas are further discussed in FIG. 2B.

FIG. 2B is a flow chart of a sub-method of generating the reference patch, according to an embodiment of the present disclosure. The first device 701 can associate the digital content with the surface area corresponding to the reference patch (e.g., via the unique identifiers included therein) generated by the first device 701. In an embodiment, the surface area may encompass the whole of the data or a portion of it.

The reference patch, which includes the unique identifier(s) corresponding to the surface area associated with the digital content, is then embedded into the data by the first device 701. In some use cases, the data including the reference patch can be sent or transmitted to a second user having the third device 702 including the same application, which then allows the second user to access information within the surface area and obtain the digital content and have it viewable on the third device 702. That is, the third device 702 can have the same data overlaid with the augmenting digital content on the surface area of the display of the third device 702 in the location or locations defined by the reference patch.

In FIG. 2B, the generating device 1001 uses additional processes to effectuate generation of the reference patch which is obtained and embedded by the first device 701. In an embodiment, the generating device 1001 encodes the reference patch with the unique identifiers corresponding to the surface area in step 205a. The generating device 1001 can mark areas of the reference patch in step 205b to form the marker that, either separately or in combination, define or may be used to access the unique identifiers. The marker can take the form of patterns, shapes, pixel arrangements, or the like. In an example, the marker can have a shape that corresponds to the shape of the surface area. In an example, the marker can have a size that corresponds to the size of the surface area. In an example, the marker can have a perimeter that corresponds to the perimeter of the surface area. The marker can use any feasible schema to provide identifying information that corresponds to the surface area within parts of the data. In an embodiment, the marker can incorporate hidden watermarks that are only detectable by the first device 701 and the third device 702, which have detection functionality implemented therein, for example having the application installed or the functionality built into the operating system.

The marker can incorporate patterns which can then be extracted by the first device 701. In an example, the first device 701 can perform the embedding, then send the digital content having the embedded reference patch to the third device 702. The encoding is performed by the generating device 1001 and may use any variety of encoding technologies such as the ARUCO algorithm to encode the reference patch by marking the reference patch with the marker. The first device 701 may also be used as the generating device 1001.

In an embodiment, the marker can be comprised of a set of points, equidistant from each other and/or some angle apart from a reference point, such as the center of the reference patch or represent some other fiducial points. That is, the fiducial points corresponding to the marker can provide a set of fixed coordinates or landmarks within the digital content with which the surface area can be mapped relative to the fiducial points. In an embodiment, the marker can be comprised of a set of unique shapes, wherein predetermined combinations of the unique shapes can correspond to a target surface area (or available area, or areas) for displaying the data. The predetermined combinations of the unique shapes can also correspond to predetermined digital content for displaying in the surface area. The predetermined combinations of the unique shapes can also correspond to/indicate a position/location where the digital content should be displayed at the surface area relative to a portion of the surface area. A combination of the set of points and unique identifiers can be used as well.

For example, the unique identifiers can be unique shapes that correlate to predetermined digital content as well as indicating where the digital content should be overlayed on the display (the screen position) relative to a set of points marked on the reference patch. The unique identifiers can also indicate a size of the digital content to be overlayed on the display, which can be adjustable based on the size of the surface area (also adjustable) and/or the size of the display of the first device 701. The unique identifiers can be relatively invisible or undetectable to the user, but readable by the first device 701 and cover predetermined areas of the reference patch. The unique identifiers, and by extension, the marker, can have an appearance that is marginally different from an appearance of the area of the reference patch. For example, the area of the reference patch can appear white to the user and the unique identifiers can also appear white to the user but may actually have a slightly darker pixel color that can be detected and interpreted by a device, such as the first device 701. For instance, the appearance of the unique identifiers can be 0.75% darker than the white color of the area of the reference patch. Such a small difference can be identified and discerned by the first device 701 while being substantially imperceptible to the user.

In an embodiment, the area of the reference patch can be divided into predetermined shapes, for instance a set of squares, and within each square, the marker (such as a “letter”) can be included. For example, there can be 16 squares. Furthermore, subsets of the set of squares can be designated to represent varying information, such as a timestamp corresponding to 8 of the squares, a domain corresponding to 5 of the squares, a version corresponding to 1 of the squares, and additional information corresponding to a remainder of the squares. An identification based on the set of squares can be, for example, an 18-character (or “letter”) hexadecimal. The set of squares can further include additional subsets for a randomization factor, which can be used for calculating a sha256 hash prior to encoding the reference patch with the hash. Together, the set of squares having the marker included therein can comprise the unique identifiers.

Moreover, the generating device 1001 can also employ chroma subsampling to mark attributes represented by a particular pattern. In an embodiment, the generating device 1001 can mark parts of the reference patch with predetermined patterns of pixel luma and chroma manipulation that represent a shape, a size, or a position of the surface area for displaying the digital content. Moreover, the generating device 1001 can mark a perimeter of the reference patch with a predetermined edging pattern of pixel luma and chroma manipulation that represents a perimeter of the surface area for displaying the digital content.

The generating device 1001 can further link the surface area with unique identifiers in step 205c. The unique identifiers can be hashed values (such as those described above) that are generated by the generating device 1001 when the reference patch is generated (such as the one having the area of the reference patch divided into the subset of squares).

FIG. 2C is a flow chart of a sub-method of associating the surface area with digital content, according to an embodiment of the present disclosure. In FIG. 2C, the generating device 1001 uses additional processes to associate the surface area with digital content. In an embodiment, the generating device 1001 can associate the unique identifiers corresponding to the surface area with metadata. In step 210a, the unique identifiers can be associated with metadata embodying information about the storage and location of the digital content. Moreover, in step 210b, the generating device 1001 can associate the unique identifier of the surface area with metadata which embodies information about the format and rendering information used for the digital content. In step 210c, the generating device 1001 can associate the unique identifiers of the surface area with metadata which embodies access control information of the digital content.

In an embodiment, the storage of the digital content can be on a remote server, such as the second device 850, and the location of the digital content can be the location address of the memory upon which it is stored at the remote server. The storage and location of the digital content are thus linked with the metadata that can point to where the digital content can later be obtained from. The digital content is not embedded into the data. In an embodiment, the format and rendering information about the digital content is embodied in the metadata and associated with the unique identifiers. This information is helpful when the first device 701 or the third device 702 are on the receiving end of the transmitted data and need to properly retrieve and process the digital content.

Moreover, in an embodiment, the access control of the digital content can also be encompassed in the metadata and associated with the unique identifiers corresponding to the surface area. The access control can be information defining whether the digital content can be accessed by certain individuals or within a certain geographical location. The access control information can define restrictions such as those placed upon time and date as to when and how long the digital content can be accessed. The access control information can define the type of display reserved for access by the first device 701. For example, a user may wish to restrict access to the digital content to certain types of devices, such as smartphone or tablets. Thus, the metadata defining a display requirement would encompass such an access control parameter.

FIG. 2D is a flow chart of a sub-method of integrating the reference patch into the data, according to an embodiment of the present disclosure. In FIG. 2D, the generating device 1001 uses additional processes to effectuate integration of the reference patch into the data. In an embodiment, the first device 701 can temporarily transfer or store the reference patch in a storage of the first device 701 in step 215a. The storage can be accessed by the first device 701 for embedding the reference patch into the data at any time. The first device 701 can extract the reference patch from the storage for embedding purposes in step 215b. The first device 701 can also arrange the reference patch at a predetermined location and with a predetermined reference patch size in step 215c. The first device 701 can further embed the reference patch such that a document, for example, having the reference patch embedded therein can be sent to a recipient, for example the second user using the third device 702, where he/she can access the document using the application on the third device 702 as further described below. Again, the features of the generating device 1001 can be performed by the first device 701.

The data can be output from a streaming application or a communication application with a data stream having the reference patch embedded therein. The actual digital content may not be sent along with the underlying data or data stream, but only the unique identifier and/or a facade of the digital content is sent. The unique identifier and/or the underlying metadata can be stored in a cloud-based database such as MySQL which can point to the second device 850 or a cloud-based file hosting platform that ultimately houses the digital content. No limitation is to be taken with the order of the operation discussed herein; such that the sub-methods performed by the first device 701 can be carried out synchronous to one another, asynchronous, dependently or independently of one another, or in any combination. These stages can also be carried out in serial or in parallel fashion.

In an embodiment, digital objects of the augmentation can be realized within a viewable area of a device software application or may reside within an entire viewable display area of the display. For instance, if a user is viewing a PDF document as the digital composition, a reference patch corresponding to a given augmentation may be within a viewable area of the PDF document and the digital content can be generated within a corresponding window through which the PDF document is being viewed. Alternatively, the reference patch can be generated within the entire viewable display area of the display and may not reside only within the corresponding window through which the PDF document is being viewed.

In an example, the digital composition is a page of a website. The webpage may be dedicated to discussions of strategy in fantasy football, a popular online sports game where users manage their own rosters of football players and points are awarded to each team based on individual performances from each football player on the team. After reading the discussion on the website page, the reader may wish to update his/her roster of football players. Traditionally, the reader would be required to open a new window and/or a new tab and then navigate to his/her respective fantasy football platform, to his/her team, and only then may the reader be able to modify his/her team. Such a digital user experience is cumbersome and inefficient. With augmentation, however, the reader may not need to leave the original webpage as a reference patch corresponding to fantasy football digital content may be positioned within the viewable area of the website page. The corresponding reference patch may be, for instance, an interactive window provided by a third-party fantasy football platform that allows the reader to modify his/her roster without leaving the original website. Thus, instead of navigating to a different website and losing view of the informative fantasy football discussion, the reader can simply interact with the digital object of the digital content in the current frame of data.

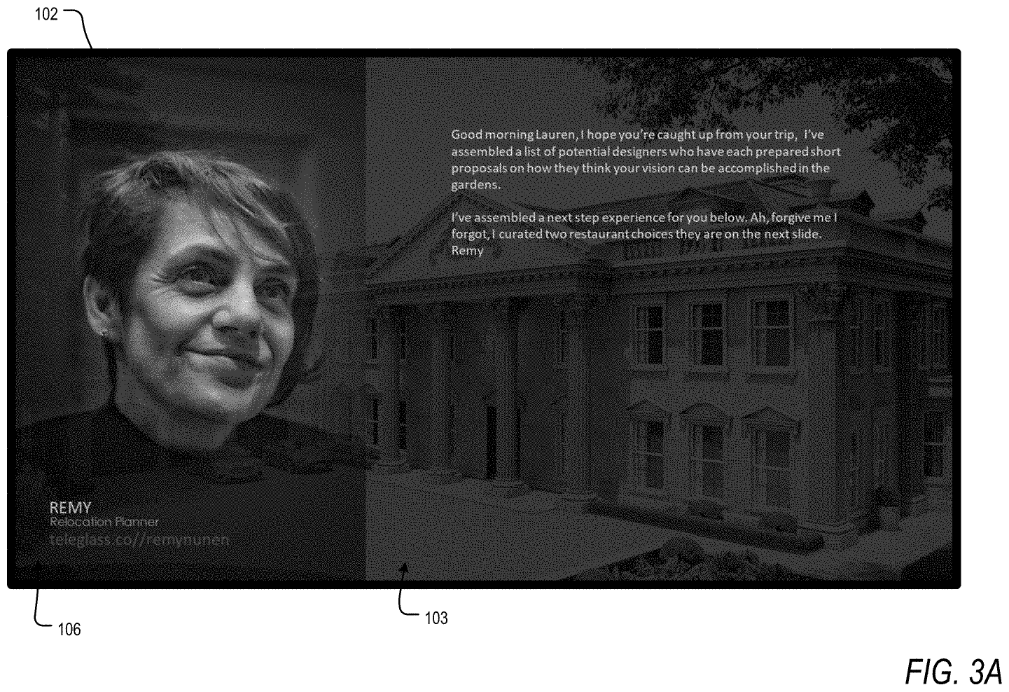

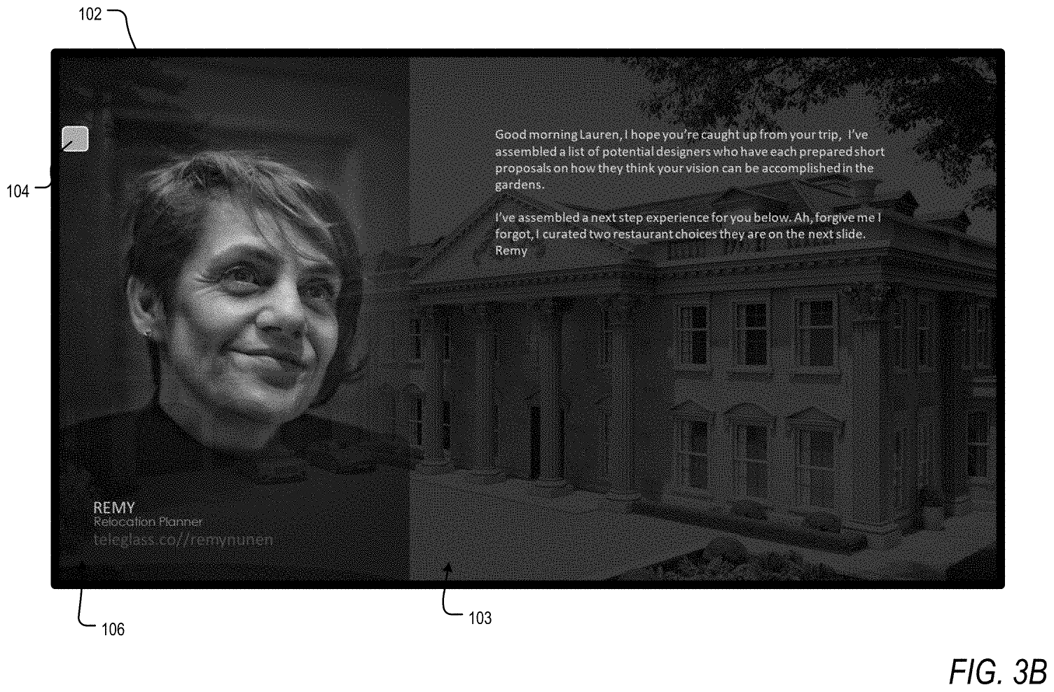

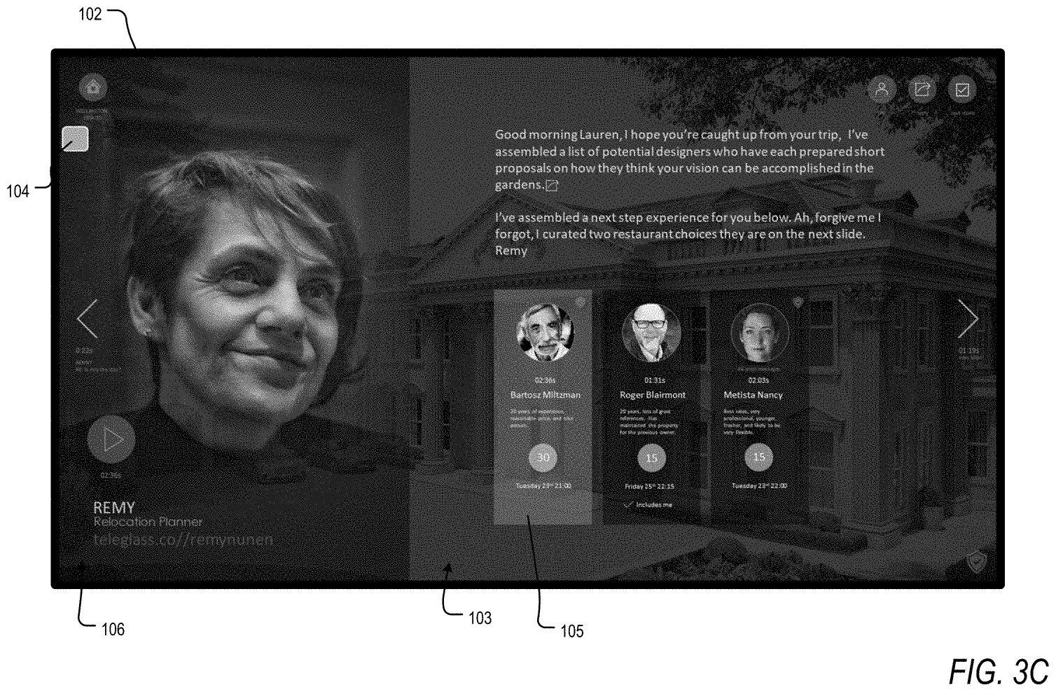

In an example, as will be described with reference to FIG. 3A through FIG. 3C, the digital composition is a slide deck. The slide deck may be generated by a concierge-type service that seeks to connect a client with potential garden designers. As in FIG. 3A, the slide deck may be presented to the client within a viewable area 103 of a display 102 of the first device 701. The presently viewable content of the slide deck within the viewable area 103 of the display 102 may be a current frame of data 106. Traditionally, the slide deck may include information regarding each potential garden designer and may direct the client to third-party software applications that allow the client to contact each designer. In other words, in order to connect with one or more of the potential garden designers, the client, traditionally, may need to exit the presentation and navigate to a separate internet web browser in order to learn more about the garden designers and connect with them. Such a digital user experience can be also cumbersome.

With augmentation, however, the client need not leave the presentation in order to set up connections with the garden designers. For instance, as shown in FIG. 3B, a reference patch 104 can be positioned within the slide deck to be in the current frame of data 106 and viewable within the viewable area 103 of the display 102 at an appropriate moment. As shown in FIG. 3C, the reference patch 104 may correspond to digital content 105 (i.e., one or more augmentations) and, when the reference patch 104 is visible to/detectable by/in an active window of the first device 701, the digital content 105 is retrieved and displayed by the first device 701 at the corresponding surface area. The digital content 105 can include, as shown in FIG. 3C, interactive buttons, images, videos, windows, and icons, among others, that allow the client to interact with the digital content and to, for instance, engage with the garden designers without leaving the presentation. In an example, the interactive digital content 105 may allow for scheduling an appointment with a given garden designer while still within the slide deck.

The above-described augmentations highlight, with reference to certain types of visual data, the problems and potential solutions associated with interactive multimedia experiences. In one embodiment, the desire to multi-task in an efficient manner, for instance, renders augmentations a possible approach.

The utility of augmentations is further appreciated with description of video data as the visual data.

In an example of a live video stream of video data as the visual data, a user may be a yoga instructor teaching a remote yoga class by Microsoft Teams. Each participant in the class may be able to view the yoga instructor via their respective devices, wherein the ‘live streamed’ video includes video of the yoga instructor guiding the participants of the class through the techniques. At the end of class, the yoga instructor may wish to receive payment from each of the participants. The instructor may open a cloud-based slide which, for instance, may have the reference patch 104, therein. The reference patch 104 may be configured to augment a pay button relative to a position of the reference patch 104 on a device display of each participant. Upon screen sharing the cloud-based slide with the participants in the class, each participant's device receives the transmitted data and processes the data for display. During processing, each device observes and detects the reference patch 104 within the data. Accordingly, each device can generate a local augmentation (i.e., retrieve and display the corresponding digital content) on a respective display in order for the participant to be able to enter the payment information and pay for the remote yoga class. The digital content may be generated within the live video stream.

In another example of a live video stream of video data as the visual data, a user may be a bank teller discussing a new savings account with a potential bank member. The bank teller may initiate a video call with the potential bank member. The bank teller may include, within a video stream being transmitted from the bank teller to the potential bank member, a reference patch. The transmitted video stream may include a video feed generated by a camera associated with a device of the bank teller. Accordingly, the transmitted video stream may include an image of, for instance, a face of the bank teller and the reference patch therein. Upon receiving the video stream, a device of the potential bank member may process the video stream and detects the reference patch. Accordingly, the device of the potential bank member may generate a local augmentation on a respective display of the device in order to allow the participant to be able to interact with the bank teller and establish the new savings account. The augmentation may happen on top of the live video stream of the bank teller. The augmentation can include a number of objects to be displayed and may be configured to display different subsets of objects based on interactions of a user with the augmentation, the objects being interactive in some cases. This allows for the augmentation to be updated in response to user interactions. For instance, an updated augmentation may reflect a step-by-step process of opening the new savings account, the augmentation being updated at each step according to the interactions of the potential bank member. First, the augmentation may request confirmation of identity, which can include instructing the potential bank member in exhibiting their driver's license such that an image of the driver's license can be obtained. The confirmation of identity may also include instruction related to and acquisition of an image of the potential bank member. Next, the augmentation may present a banking contract to the potential bank member, the potential bank member then being able to review and sign the banking contract. Lastly, the augmentation can request the potential bank member provide verbal confirmation of the approval of the bank contract. Each of these steps can be associated with a same reference patch corresponding to an augmentation that guides the ‘new’ bank member along the account setup process.

According to an embodiment, a reference patch may be used to generate local augmentations for a variety of implementations. Such implementations can include renewing a motor vehicle driver's license, signing a contract, obtaining a notarization from a notary public, renewing a travel document, and the like.

According to an embodiment, a reference patch can be inserted into, as the visual data, recorded video data that is to be displayed on a device of an end user. In an example, the device decodes the recorded video and, based on the detected presence of the reference patch, can locally-augment the display of the device to overlay the intended augmentation on the recorded video. The design and the arrangement of the augmentation can be provided relative to the reference patch placed into the digital content. The reference patch may be placed into the digital content, or recorded video data, by the original content creator or by another party that wishes to enhance the user visual experience. A variety of examples will be described below.

In an example, a music video having a reference patch may be played over a video player (e.g., Vimeo) by a fan. The reference patch may allow a local augmentation that makes it possible for the fan to purchase tickets to the artist's next live concert that is within a predefined radius of a current address, home address, or other address associated with the fan. Here, the live concerts that are loaded in the augmentation over the music video, that is being played over the video player, is personalized to each fan and their respective location. The reference patch allows the live concert data to be loaded in real-time.

In another example, a recorded educational video from, for instance, Khan Academy can have a reference patch that triggers a quiz for a student watching the video. In this way, the video can be paused while the augmentation is rendered and the student completes the quiz within the overlayed digital content. Once the quiz has been completed, the student may proceed to the next segment of the video.

The above-described examples illustrate the utility of digital content augmented into data. They can provide dynamic user experiences that integrate multiple functionalities onto a single display area.

The present disclosure is directed to augmentations of a display area of the first device 701, such as a smartphone or mobile device, when the user is engaged in a voice call. As previously discussed in FIG. 2A with reference to step 205, with reference to visual data as digital content, augmentations of the digital user experience can be realized through incorporation of a reference patch corresponding to the digital content into the visual data. In a similar fashion, for mobile devices capable of sending and receiving audio files and audio data, when the user is engaged in a voice call, an audio reference patch may be embedded within the audio data, and the digital content may be generated on the display area of the first device 701 in response to detection of the audio reference patch in the audio data in real-time. In other words, a reference patch that is embedded in audio data transmitted during a phone call (or voice call), can produce a visual augmentation (or generate displayed data) on the screen of the mobile device.

In an embodiment, the present disclosure describes a method for augmenting data with digital content. The digital content can be generated within a transparent layer overlaying native layer(s) of a display of the first device 701. The digital content can be generated in response to detecting the audio reference patch within audio data transmitted over a communication network during a voice call. Detecting the audio reference patch initiates a query that matches the audio reference patch with a reference audio reference patch in a database stored at an external device (for example, a server such as the second device 850). The reference audio reference patch, which is associated with predetermined digital content, can then be used to render a local augmentation on the display of the first device 701. In an embodiment, the digital composition can include a real-time audio stream of audio data. In an embodiment, digital composition can include programmed audio.

In other words, the method includes encoding and decoding of an audio reference patch that has added to an audio file including audio data. An encoded audio reference patch can be added to an audio file in a manner similar to that described above for (non-audio) reference patches in visual data. The first device 701 can receive the audio file, process it, and detect the audio reference patch within the audio file. For example, similar to the reference patch, the audio reference patch can have a unique identifier, wherein the unique identifier of the audio reference patch can be an acoustic fingerprint or unique identifying audio pattern that can be detected by the first device 701. The unique identifier of the audio reference patch can be, for example, an audio pattern with frequencies outside the hearing range of humans (e.g., outside the range of 20 Hz to 20 kHz).

The unique identifier of the audio reference patch can be, for example, an audio pattern with a maximum volume below a predetermined threshold, wherein the predetermined threshold is determined by an average volume of the audio file so as to not be disruptive to the user trying to listen to the audio file. For the unique identifier of the audio reference patch having frequencies outside the human hearing range, the first device 701 can detect frequencies outside the human hearing range and be configured to listen for and detect the unique identifier of the audio reference patch. Notably, the unique identifier of the audio reference patch having frequencies outside the human hearing range can help prevent disrupting the user trying to listen to the audio file since the user cannot hear the frequencies of the unique identifier of the audio reference patch.

Upon detecting the audio reference patch, the first device 701 can decode the encoded audio reference patch. For example, similar to the reference patch, the unique identifier of the audio reference patch can include encoded data that identifies the digital content, a location address of the digital content at the second device 850 (such as a server), a screen position within the surface area at which the digital content is insertable in the data, and a size of the digital content when inserted in the data (adjustable before being displayed). The encoded data can be, for example, instructions to perform server calls to obtain the digital content.

Upon decoding the audio reference patch, the first device 701 can then query the remote device and retrieve the digital content based on the unique identifiers corresponding to the detected audio reference patch.

The first device 701 can then run a visual experience over the voice calling application (for example, the native phone app) used to make the voice call by overlaying the digital content onto the surface area of the data based on the unique identifiers of the audio reference patch.

In a first exemplary implementation of the present disclosure, a user may call a restaurant using his/her smartphone. An automated answering service may answer the call on behalf of the restaurant. Upon answering the call, the automated answering service may transmit audio data including the audio reference patch to the smartphone/mobile device (for example, device 701). The smartphone may detect the presence of the audio reference patch within the transmitted audio data. Subsequently, the smartphone may query a server, such as the second device 850, in order to match and identify the detected audio reference patch based on reference audio reference patches. Upon identifying the audio reference patch, instructions for generating a local (on the smartphone/device 701) augmentation with retrieved digital content from the remote device on the smartphone can be obtained. The digital content may include visual graphics presenting opening and closing times of the restaurant, current seating availability, and the like. This allows the phone call to be an entirely interactive experience on the basis of the audio reference patch being placed within the transmitted audio data. In an example, and after evaluating the current seating availability, the user can select a date and a time to dine and provide credit card information in order to hold the reservation.

In a second exemplary implementation of the present disclosure, a user may call an airline in order to change something about an upcoming flight. The automated answering service may indicate that the wait time to speak with a live agent is 30 minutes. The automated answering service may also offer, as an alternative, an interactive voice call experience. When the user selects the interactive voice call experience, the audio reference patch may be transmitted within audio data to the smartphone. The smartphone may receive the audio data and detect the presence of the audio reference patch. Subsequently, the smartphone may query the server, such as the second device 850, in order to match and identify the detected audio reference patch based on reference audio reference patches. Upon identifying the audio reference patch, instructions for generating a local augmentation using the retrieved digital content can be obtained. The digital content may include visual graphics presenting alternative flight options. The alternative flight options may be based on a flight confirmation number provided by the user. The digital content may allow for payment to be received for processing the requested flight change. The digital content may also include a user input graphic for identity confirmation (e.g., two-factor authentication), wherein the user may enter numbers of a digital pin sent to the smartphone of the user via SMS.

It can be appreciated that the above-described examples are one-to-one experiences. In another instance, the method of the present disclosure may be implemented between one device and many devices. The experiences can be unattended or attended. The experiences can be personalized or same for all. The experiences can be remote controlled or synchronized.

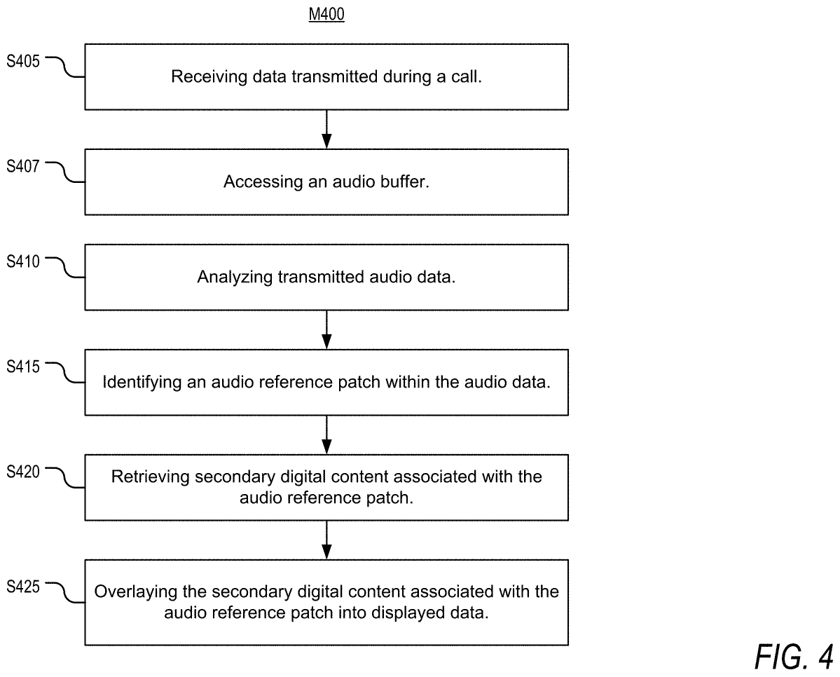

According to an embodiment, and with reference again to the Drawings, FIG. 4 provides a flow diagram of a method M400 for augmenting data with secondary digital content. Method M400 is described from the perspective of a mobile device, such as a smartphone, such as the first device 701, that is configured to receive data (such as audio data) and receive user input thereon.

At step S405 of method M400, data transmitted over a communication network can be received by the first device 701. The data can include audio data as well as visual displayed data. The audio data may be received in response to a user of the mobile device, or calling party, dialing a specific called party.

At step S407 of method M400, the first device 701 can inspect the stream of audio data being output by the first device 701. That is, the first device 701 can access the audio buffer of the first device 701.

At step S410 of method M400, the first device 701 can analyze or listen to the outputted stream of audio data. The first device 701 can achieve this by intercepting and capturing data produced from the first device 701's sound controller 620 (see FIG. 6). An audio reference patch (or more than one audio reference patch) associated with the transmitted audio data can be observed by the first device 701.

At step S415 of method M400, an audio reference patch within the audio data can be detected or identified. The identification can be performed according to one of a variety of audio processing techniques that can be used for audio processing detection. For example, the first device 701 can use template matching, which matches the features of the audio data to a pre-recorded/pre-saved and defined template. For example, the first device 701 can use machine learning to perform audio feature extraction and sound classification and segmentation.

In an example, the audio reference patch may include (or correspond to) an acoustic fingerprint that is detected by analyzing a spectrogram of the audio data and comparing the spectrogram to a reference database of spectrograms corresponding to known acoustic fingerprints. The acoustic fingerprint (the unique identifier) can then be used at step S420 of method M400 to retrieve the digital content.

In an example, the audio reference patch can be identified based on a predetermined audio frequency or range of frequencies. For example, the range of frequencies may not be present in the audio data audible to the user (in other words, it may be in a range of frequencies that are not audible to the user).

In an example, the audio reference patch may include (or correspond to) an acoustic flag that is followed by an acoustic identifier. The acoustic identifier can be a set of predetermined data, such as audio data, used to quickly locate the audio reference patch. The acoustic identifier can, similar to the unique identifier, be associated with the digital content. The acoustic identifier can then be used at step S420 of method M400 to retrieve the digital content.

In an example, the audio reference patch may include (or correspond to) an audio watermark within the audio data of the transmitted digital content. The audio reference patch may further include (or correspond to), following the audio watermark or contained within the audio watermark, the acoustic identifier. The acoustic identifier may then be used at step S420 of method M400 to retrieve augmentation rendering instructions.

Watermarking is the process of embedding information into a signal (e.g., audio) in a way that is difficult to remove. Watermarks can be extracted by detection mechanisms and decoded. Audio watermarking schemes rely on imperfections of the human auditory system.

In an embodiment, the audio data of the transmitted digital content of the present disclosure may include an audio watermark that is generated by, among others, spread-spectrum method in Cepstrum domain, watermarking in the time domain, or time-spread echo method.

As it relates to the spread-spectrum method in Cepstrum domain, a narrow-band signal is transmitted over a much larger bandwidth such that the signal energy presented in any signal frequency is undetectable. Thus, the watermark is spread over many frequency bands so that the energy in one band is undetectable. Spreading spectrum can be achieved by embedding a pseudo-random sequence (PRS) within cepstral components. Detection of the audio watermark can be accomplished by calculating a correlation between the PRS and the watermarked audio data. The detected audio watermark may then indicate the presence of an audio reference patch and a subsequent segment of audio data can be acquired is the acoustic identifier. A length of the subsequent segment of audio data may be defined by a given implementation of the method.

As it relates to watermarking in the time domain, an audio masking method in time and frequency can be used to slightly modify the amplitude of each audio sample, which can then be detected upon receipt of the audio data.

As it relates to the time-spread echo method, an imperceptible echo may be spread in the time domain using pseudo-noise (PN) sequences, and the PN sequences can be used to identify the audio watermark upon audio data processing.

In an embodiment, the spread-spectrum method in Cepstrum domain is used for embedding the audio watermark and the audio reference patch is detected based on the correlation method described above. Accordingly, at step S420 of method M400, the detected audio reference patch can be used to retrieve instructions associated with overlaying the digital content associated with the audio reference patch. In other words, each audio reference patch includes the audio watermark and the acoustic identifier that, upon being detected at step S415 of method M400, can be used to obtain rendering instructions related to locally overlaying the digital content on a display of a device.

Having obtained the rendering instructions, method M400 proceeds to step S425 and the digital content of the user visual experience can be realized. This can include displaying, based on the rendering instructions, object(s) of the digital content within a transparent layer of the display of the first device 701. The transparent layer of the display may be a topmost layer of the display to ‘overlay’ the digital content on the underlying data. In an embodiment, the processing circuitry of the first device 701/the smartphone is configured to iteratively perform the receiving, the analyzing, the detecting, and the overlaying.

For example, in the case of a mobile device, the reference patch can be embedded in an application (“app”) on the mobile device such as the native phone app that is used to make and receive voice/phone calls. This app can include a user interface that allows the user to temporarily turn the microphone off, control a volume of a speaker that projects audio coming from the other call participant, end the call, and the like.

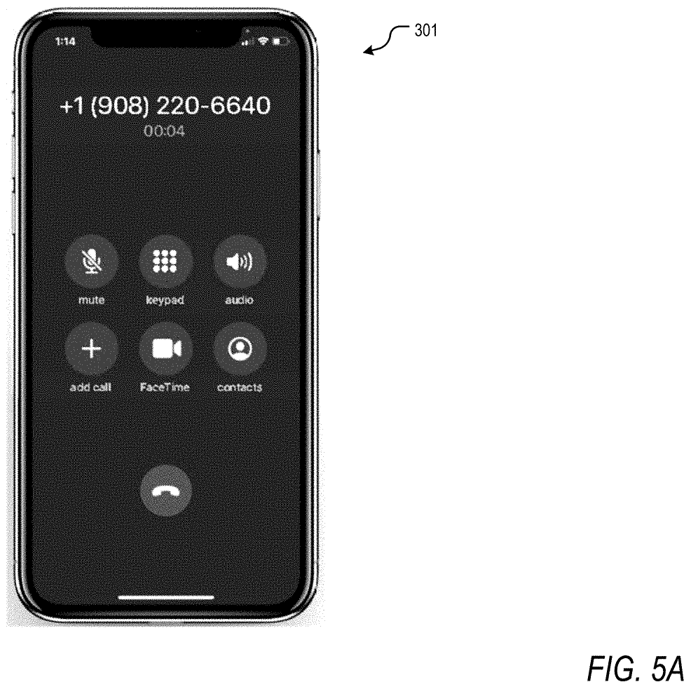

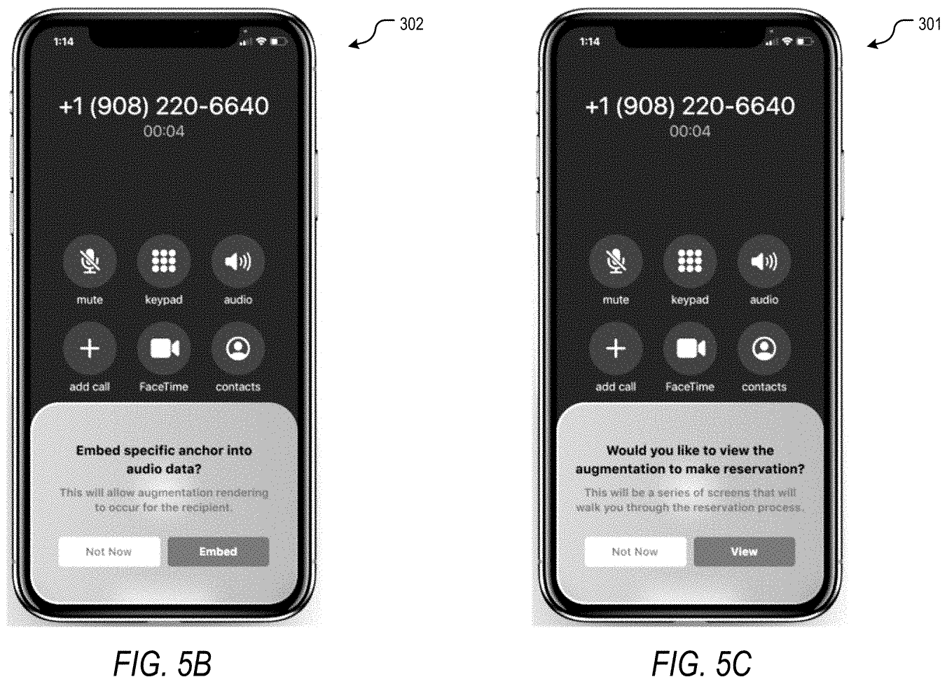

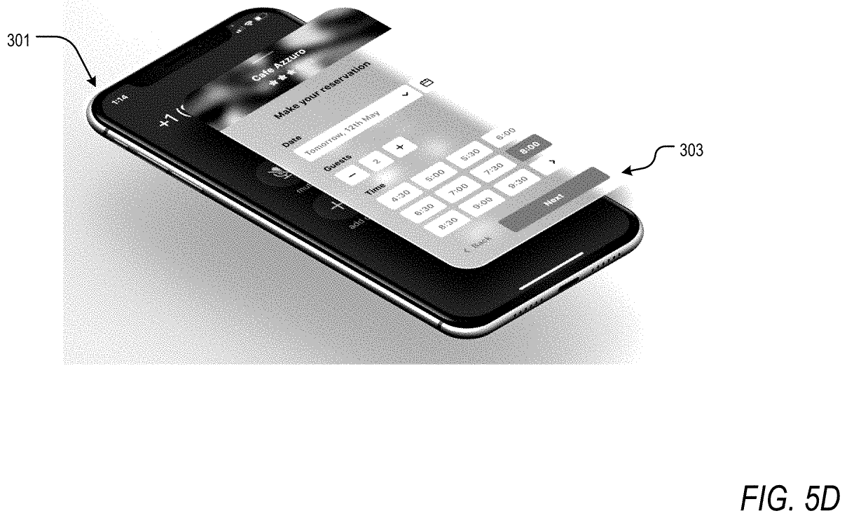

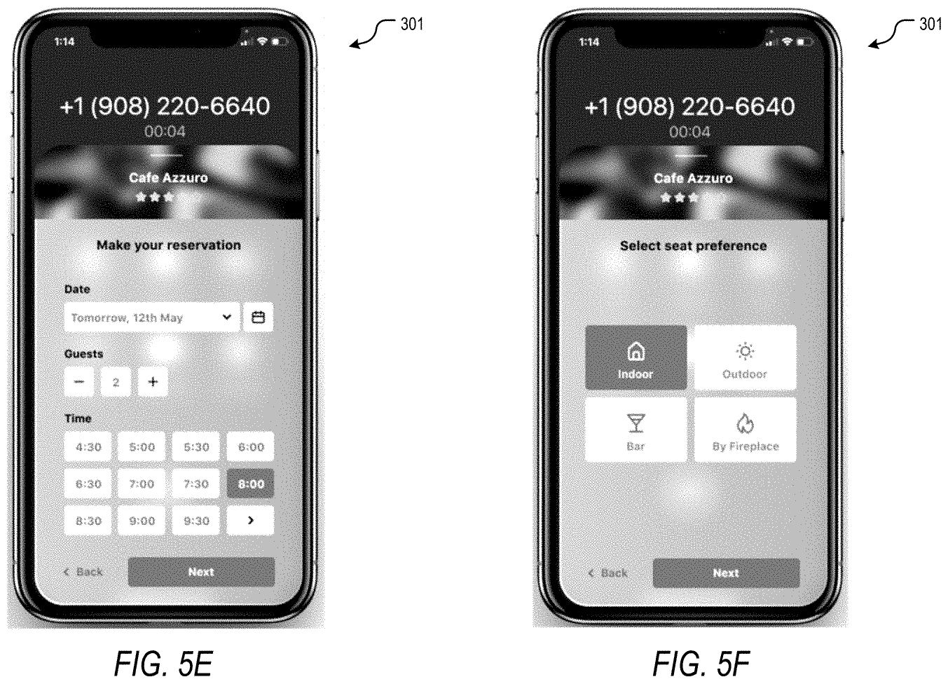

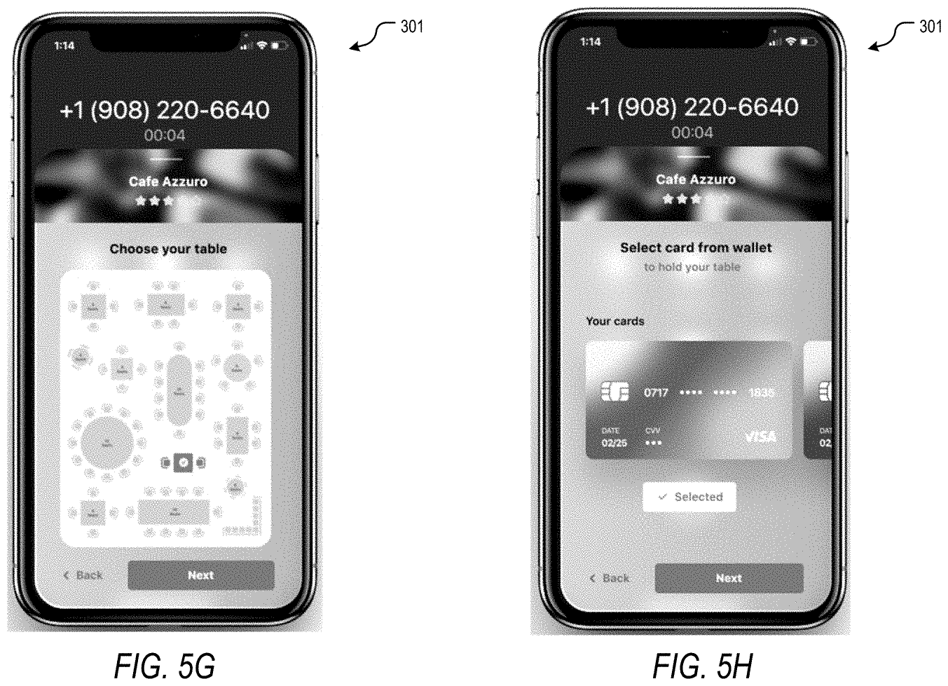

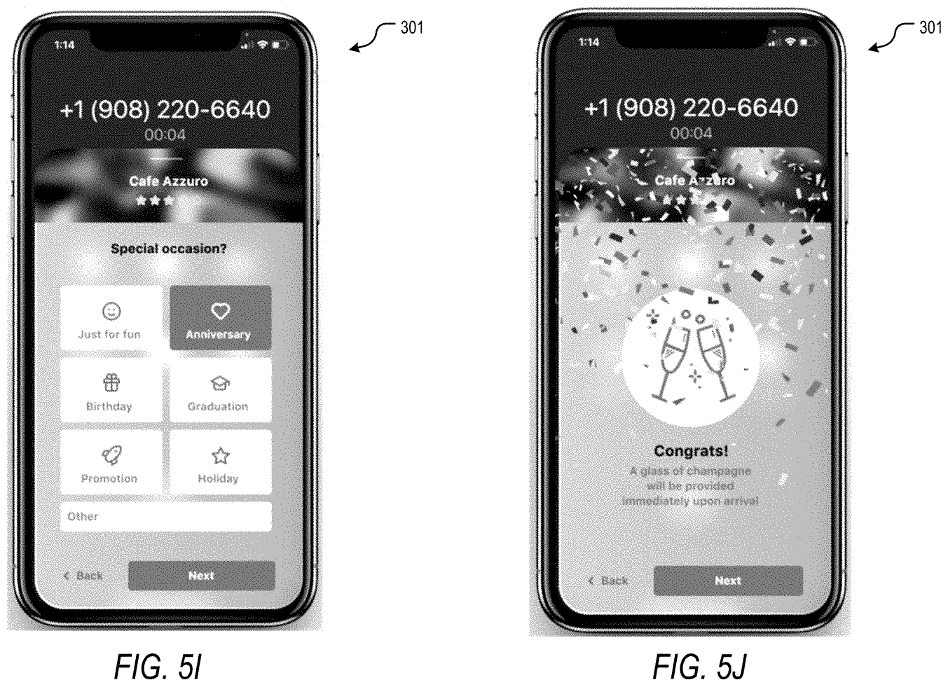

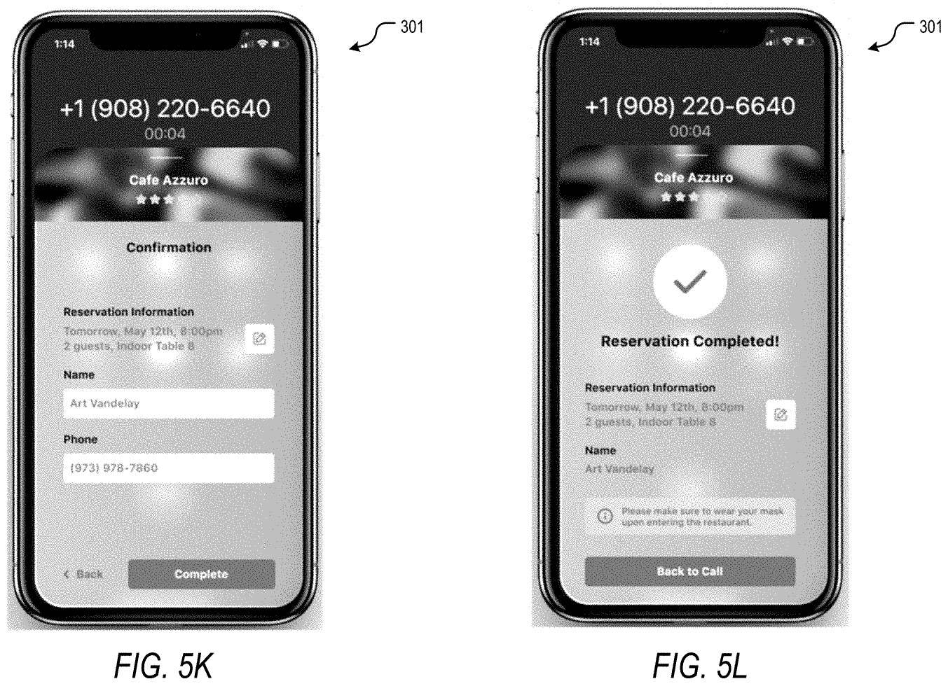

With reference now to FIG. 5A through FIG. 5L, an exemplary implementation of the methods described herein is illustrated, wherein a user of a first device desires to make a dining reservation at a restaurant a second device is associated with.

In an embodiment, FIG. 5A is an illustration of a first device 301, such as a smartphone or the first device 701, engaged in a voice call with a second device 302, as shown in FIG. 5B. The second device 302 may be a mobile device, such as smartphone, laptop, or tablet, or a stationary device, such as a desktop computer, or the second device 850. In an embodiment, the second device 302 is a server like that of the second device 850 and the below-described experience is an automated answering service providing an automated customer experience. The immediate example below, however, will be described assuming both devices are controlled by a human user. Note that, in an embodiment, the voice call in this example can be a phone call that relies on a cellular network, as opposed to a Voice over Internet Protocol (VoIP) call that relies on an Internet connection. However, in an embodiment, the voice call can be a VoIP call.

It can be appreciated from FIG. 5A that, without augmentation, a display of the first device 301 includes only standard functionality such as mute, keypad, audio, add call, and end call, among others (for example, a native phone app). In an embodiment, the voice call between the first device 301 and the second device 302 may be initiated by the first device 301. As described above, the second device 302 may be associated with a restaurant.

FIG. 5B illustrates the second device 302 after having initially received the phone call from the first device 301 and after having received an indication that the user of the first device 301 wishes to reserve a table for dining. Accordingly, instead of immediately talking the user of the first device 301 through the reservation process, the user of the second device 302 may select to embed a specific audio reference patch (or anchor) into audio data being transmitted from the second device 302 to the first device 301. The query of the user of the second device 302 may be executed via an augmentation on the second device 302, the augmentation being generated in response to the second device 302 identifying and understanding the speech of the user of the first device 301 as being a dining reservation.

Upon receiving the audio data from the second device 302, the first device 301 may detect the specific audio reference patch. The first device 301 may then retrieve, from cloud-based storage, remote storage, or local storage, instructions for rendering an augmentation or digital content associated with the specific audio reference patch. The retrieval may be based on, for instance, matching a unique identifier of the specific audio reference patch with reference audio reference patches. In this example, the specific audio reference patch is associated with a dining reservation augmentation.

Having retrieved the rendering instructions, the user of the first device 301 may then be asked, via augmentation on the first device 301, if he/she would like to use the augmentation-based reservation system. As described herein, the initial user query may be a part of the reservation augmentation. The initial user query may also be a separate augmentation associated with a separate audio reference patch. It can be readily appreciated, in view of the present disclosure, how such a method operates (e.g., second device 302 transmitted another audio reference patch after receiving an indication the user of the first device 301 wishes to proceed with the augmentation). In an embodiment, the initial user query may be a spoken query that requires a response in the form of keypad strokes or verbal commands performed by the user of the first device 301.

Assuming the initial user query is part of the dining reservation augmentation, as in FIG. 5C, the user may exit the augmentation by selecting ‘Not Now’ on the first device 301, the reservation thereby proceeding as human-driven between the user of the first device 301 and the user of the second device 302. If the user of the first device 301 would like to continue use of the augmentation-based reservation system, however, the user may select ‘View’ on the augmentation of the first device 301. Note that, in an embodiment, the user may not be prompted to respond and the augmentation may automatically be displayed on the first device 301 without any user input.

In an embodiment, the augmentation may be generated within a transparent layer of a user interface of the first device 301. Note that, as noted above, the user interface in this example corresponds to a native phone application (phone app) on the smartphone/first device 301. As appreciated with reference to FIG. 5D, a transparent layer 303 can be overlaid on native layers (or layers of applications not native to the particular device/smartphone) of the user interface and displayed on a display of the first device 301. Thus, the digital content can be in a foreground of the display of the first device 301 and, thus, interactive to the user. The digital content may feature a horizontal stripe to allow the digital content to be minimized and a ‘Back’ feature and a ‘Next’ feature to allow a user to modify the displayed information in real-time. Of course, other features may be practical in order to allow for a pleasant user experience.

Returning to the dining reservation augmentation, it can be appreciated that a user of the first device 301 has placed a voice call to the restaurant and a user of the second device 302, or a host at the restaurant, has received the voice call. The user of the first device 301 has indicated, via a user interface of the first device 301, a desire to reserve a table for dinner. The host, in response, has selected an option on a user interface of the second device 302 to embed a specific audio reference patch into audio data being transmitted to the first device 301. Upon receiving the transmitted audio data, the specific audio reference patch was detected by the first device 301 and digital content rendering instructions were obtained based on a unique identifier therein.

With reference now to FIG. 5E, and after initialization of the digital content augmentation over the data on the display of the first device 301 and an indication that the user wishes to proceed with the digital content augmentation, the user may, without ending the phone call, begin to interact with the digital content to proceed with a dinner reservation process. Initially, the user, or diner, may be presented with an interface requesting a desired party size, date, and time for the reservation. In this case, the diner indicates via tactile interface of the display of the first device 301 a desire to reserve a table for two for dinner tomorrow evening at 8:00 p.m. Upon receiving the indications, the first device 301 queries the diner for seat preference (e.g., indoor seating, outdoor seating, etc.), as shown in FIG. 5F. Upon receiving an indication from the diner that indoor seating is preferred, the first device 301 may communicate with a server, a cloud-based computing environment, or the second device 302, or the second device 850, to determine if there is matching availability for the party size, date, time, and seating preference indicated by the diner. In an embodiment, any relevant data associated with current dining reservations and seating occupancies of the restaurant may be transmitted to the first device 301 with the initial rendering instructions and, thus, subsequent queries can be answered by probing local storage.

After determining a match exists between the requests of the diner and restaurant availabilities, the digital content of the first device 301 may display a seating chart, as shown in FIG. 5G, allowing the diner to select a specific table based on a map of the available seating options and a map of the restaurant. In this case, the digital content displays only one table for two. Accordingly, the first device 301 receives an indication from the user of a preference for the table for two. In order to finalize the reservation, as shown in FIG. 5H, the digital content of the first device 301 may display a payment information graphic that allows the diner to indicate a payment methodology in order to hold the table. The payment methodology may be, for instance, a credit card within a mobile wallet. At this time, as shown in FIG. 5I, the digital content of the first device 301 may generate a graphic asking the diner if the reservation is associated with a special occasion. In this case, the diner indicates the occasion is an anniversary dinner. Upon receiving the indication, the digital content of the first device 301 directly generates a live, dynamic confetti graphic, as shown in FIG. 5J, and, separately, notes that a glass of champagne should be provided to the couple immediately upon arrival at the restaurant. To end the user interaction, as in FIG. 5K and FIG. 5L, the digital content of the first device 301 may display, at some level, the data entered by the user throughout the augmentation and request a final confirmation of the dining reservation from the user. Indication of the final confirmation may be transmitted between the first device 301 and the second device 302, or other computer system associated with the restaurant, in order to record the dining reservation. A reservation confirmation may then be displayed as an augmentation on the first device 301.

Embodiments of the subject matter and the functional operations described in this specification can be implemented by digital electronic circuitry, in tangibly embodied computer software or firmware, in computer hardware, including the structures disclosed in this specification and their structural equivalents, or in combinations of one or more of them. Embodiments of the subject matter described in this specification can be implemented as one or more computer programs, i.e., one or more modules of computer program instructions encoded on a tangible non-transitory program carrier for execution by, or to control the operation of data processing apparatus. The computer storage medium can be a machine-readable storage device, a machine-readable storage substrate, a random or serial access memory device, or a combination of one or more of them.

The term “data processing apparatus” refers to data processing hardware and may encompass all kinds of apparatus, devices, and machines for processing data, including by way of example a programmable processor, a computer, or multiple processors or computers. The apparatus can also be or further include special purpose logic circuitry, e.g., an FPGA (field programmable gate array) or an ASIC (application-specific integrated circuit). The apparatus can optionally include, in addition to hardware, code that creates an execution environment for computer programs, e.g., code that constitutes processor firmware, a protocol stack, a database management system, an operating system, or a combination of one or more of them.

A computer program, which may also be referred to or described as a program, software, a software application, a module, a software module, a script, or code, can be written in any form of programming language, including compiled or interpreted languages, or declarative or procedural languages, and it can be deployed in any form, including as a stand-alone program or as a module, component, Subroutine, or other unit suitable for use in a computing environment. A computer program may, but need not, correspond to a file in a file system. A program can be stored in a portion of a file that holds other programs or data, e.g., one or more scripts stored in a markup language document, in a single file dedicated to the program in question, or in multiple coordinated files, e.g., files that store one or more modules, sub-programs, or portions of code. A computer program can be deployed to be executed on one computer or on multiple computers that are located at one site or distributed across multiple sites and interconnected by a communication network.

The processes and logic flows described in this specification can be performed by one or more programmable computers executing one or more computer programs to perform functions by operating on input data and generating output. The processes and logic flows can also be performed by, and apparatus can also be implemented as, special purpose logic circuitry, e.g., an FPGA an ASIC.

Computers suitable for the execution of a computer program include, by way of example, general or special purpose microprocessors or both, or any other kind of central processing unit. Generally, a CPU will receive instructions and data from a read-only memory or a random-access memory or both. Elements of a computer are a CPU for performing or executing instructions and one or more memory devices for storing instructions and data. Generally, a computer will also include, or be operatively coupled to receive data from or transfer data to, or both, one or more mass storage devices for storing data, e.g., magnetic, magneto-optical disks, or optical disks. However, a computer need not have such devices. Moreover, a computer can be embedded in another device, e.g., a mobile telephone, a personal digital assistant (PDA), a mobile audio or video player, a game console, a Global Positioning System (GPS) receiver, or a portable storage device, e.g., a universal serial bus (USB) flash drive, to name just a few. Computer-readable media suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto optical disks; and CD-ROM and DVD-ROM disks. The processor and the memory can be supplemented by, or incorporated in, special purpose logic circuitry.

To provide for interaction with a user, embodiments of the subject matter described in this specification can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's device in response to requests received from the web browser.

Embodiments of the subject matter described in this specification can be implemented in a computing system that includes a back-end component, e.g., as a data server, or that includes a middleware component, e.g., an application server, or that includes a front-end component, e.g., a client computer having a graphical user interface or a Web browser through which a user can interact with an implementation of the subject matter described in this specification, or any combination of one or more Such back-end, middleware, or front-end components. The components of the system can be interconnected by any form or medium of digital data communication, e.g., a communication network. Examples of communication networks include a local area network (LAN) and a wide area network (WAN), e.g., the Internet.

The computing system can include clients (user devices) and servers. A client and server are generally remote from each other and typically interact through a communication network. The relationship of client and server arises by virtue of computer programs running on the respective computers and having a client-server relationship to each other. In an embodiment, a server transmits data, e.g., an HTML page, to a user device, e.g., for purposes of displaying data to and receiving user input from a user interacting with the user device, which acts as a client. Data generated at the user device, e.g., a result of the user interaction, can be received from the user device at the server.

Electronic device 600 shown in FIG. 6 can be an example of one or more of the devices shown in FIG. 1. In an embodiment, the device 600 may be a smartphone. However, the skilled artisan will appreciate that the features described herein may be adapted to be implemented on other devices (e.g., a laptop, a tablet, a server, an e-reader, a camera, a navigation device, etc.). The device 600 of FIG. 6 includes processing circuitry, as discussed above. The processing circuitry includes one or more of the elements discussed next with reference to FIG. 6. The device 600 may include other components not explicitly illustrated in FIG. 6 such as a CPU, GPU, frame buffer, etc. The device 600 includes a controller 410 and a wireless communication processor 402 connected to an antenna 401. A speaker 404 and a microphone 405 are connected to a voice processor 403.

The controller 410 may include one or more Central Processing Units processors/processing circuitry (CPU, GPU, or other circuitry) and may control each element in the user device 600 to perform functions related to communication control, audio signal processing, graphics processing, control for the audio signal processing, still and moving image processing and control, and other kinds of signal processing. The controller 410 may perform these functions by executing instructions stored in a memory 450. Alternatively, or in addition to the local storage of the memory 450, the functions may be executed using instructions stored on an external device accessed on a network or on a non-transitory computer readable medium.

The memory 450 includes but is not limited to Read Only Memory (ROM), Random Access Memory (RAM), or a memory array including a combination of volatile and non-volatile memory units. The memory 450 may be utilized as working memory by the controller 410 while executing the processes and algorithms of the present disclosure. Additionally, the memory 450 may be used for long-term storage, e.g., of image data and information related thereto.

The user device 600 includes a control line CL and data line DL as internal communication bus lines. Control data to/from the controller 410 may be transmitted through the control line CL. The data line DL may be used for transmission of voice data, audio data, visual displayed data, etc.

The antenna 401 transmits/receives electromagnetic wave signals between base stations for performing radio-based communication, such as the various forms of cellular telephone communication. The wireless communication processor 402 controls the communication performed between the user device 600 and other external devices via the antenna 401. For example, the wireless communication processor 402 may control communication between base stations for cellular phone communication.

The speaker 404 emits an audio signal corresponding to audio data supplied from the voice processor 403. The microphone 405 detects surrounding audio and converts the detected audio into an audio signal. The audio signal may then be output to the voice processor 403 for further processing. The voice processor 403 demodulates and/or decodes the audio data read from the memory 450 or audio data received by the wireless communication processor 402 and/or a short-distance wireless communication processor 407. Additionally, the voice processor 403 may decode audio signals obtained by the microphone 405.

The exemplary user device 600 may also include a display 420, a touch panel 430, an operation key 440, and a short-distance communication processor 407 connected to an antenna 406. The display 420 may be a Liquid Crystal Display (LCD), an organic electroluminescence display panel, or another display screen technology. In addition to displaying still and moving image data, the display 420 may display operational inputs, such as numbers or icons which may be used for control of the user device 600. The display 420 may additionally display a GUI for a user to control aspects of the user device 600 and/or other devices. Further, the display 420 may display characters and images received by the user device 600 and/or stored in the memory 450 or accessed from an external device on a network. For example, the user device 600 may access a network such as the Internet and display text and/or images transmitted from a Web server.

The touch panel 430 may include a physical touch panel display screen and a touch panel driver. The touch panel 430 may include one or more touch sensors for detecting an input operation on an operation surface of the touch panel display screen. The touch panel 430 also detects a touch shape and a touch area. Used herein, the phrase “touch operation” refers to an input operation performed by touching an operation surface of the touch panel display with an instruction object, such as a finger, thumb, or stylus-type instrument. In the case where a stylus or the like is used in a touch operation, the stylus may include a conductive material at least at the tip of the stylus such that the sensors included in the touch panel 430 may detect when the stylus approaches/contacts the operation surface of the touch panel display (similar to the case in which a finger is used for the touch operation).

In certain aspects of the present disclosure, the touch panel 430 may be disposed adjacent to the display 420 (e.g., laminated) or may be formed integrally with the display 420. For simplicity, the present disclosure assumes the touch panel 430 is formed integrally with the display 420 and therefore, examples discussed herein may describe touch operations being performed on the surface of the display 420 rather than the touch panel 430. However, the skilled artisan will appreciate that this is not limiting.

For simplicity, the present disclosure assumes the touch panel 430 is a capacitance-type touch panel technology. However, it should be appreciated that aspects of the present disclosure may easily be applied to other touch panel types (e.g., resistance-type touch panels) with alternate structures. In certain aspects of the present disclosure, the touch panel 430 may include transparent electrode touch sensors arranged in the X-Y direction on the surface of transparent sensor glass.

The touch panel driver may be included in the touch panel 430 for control processing related to the touch panel 430, such as scanning control. For example, the touch panel driver may scan each sensor in an electrostatic capacitance transparent electrode pattern in the X-direction and Y-direction and detect the electrostatic capacitance value of each sensor to determine when a touch operation is performed. The touch panel driver may output a coordinate and corresponding electrostatic capacitance value for each sensor. The touch panel driver may also output a sensor identifier that may be mapped to a coordinate on the touch panel display screen. Additionally, the touch panel driver and touch panel sensors may detect when an instruction object, such as a finger is within a predetermined distance from an operation surface of the touch panel display screen. That is, the instruction object does not necessarily need to directly contact the operation surface of the touch panel display screen for touch sensors to detect the instruction object and perform processing described herein. For example, in certain embodiments, the touch panel 430 may detect a position of a user's finger around an edge of the display 420 (e.g., gripping a protective case that surrounds the display/touch panel). Signals may be transmitted by the touch panel driver, e.g., in response to a detection of a touch operation, in response to a query from another element based on timed data exchange, etc.

The touch panel 430 and the display 420 may be surrounded by a protective casing, which may also enclose the other elements included in the user device 600. In an embodiment, a position of the user's fingers on the protective casing (but not directly on the surface of the display 420) may be detected by the touch panel 430 sensors. Accordingly, the controller 410 may perform display control processing described herein based on the detected position of the user's fingers gripping the casing. For example, an element in an interface may be moved to a new location within the interface (e.g., closer to one or more of the fingers) based on the detected finger position.

Further, in an embodiment, the controller 410 may be configured to detect which hand is holding the user device 600, based on the detected finger position. For example, the touch panel 430 sensors may detect a plurality of fingers on the left side of the user device 600 (e.g., on an edge of the display 420 or on the protective casing), and detect a single finger on the right side of the user device 600. In this exemplary scenario, the controller 410 may determine that the user is holding the user device 600 with his/her right hand because the detected grip pattern corresponds to an expected pattern when the user device 600 is held only with the right hand.

The operation key 440 may include one or more buttons or similar external control elements, which may generate an operation signal based on a detected input by the user. In addition to outputs from the touch panel 430, these operation signals may be supplied to the controller 410 for performing related processing and control. In certain aspects of the present disclosure, the processing and/or functions associated with external buttons and the like may be performed by the controller 410 in response to an input operation on the touch panel 430 display screen rather than the external button, key, etc. In this way, external buttons on the user device 600 may be eliminated in lieu of performing inputs via touch operations, thereby improving watertightness.

The antenna 406 may transmit/receive electromagnetic wave signals to/from other external apparatuses, and the short-distance wireless communication processor 407 may control the wireless communication performed between the other external apparatuses. Bluetooth, IEEE 802.11, and near-field communication (NFC) are non-limiting examples of wireless communication protocols that may be used for inter-device communication via the short-distance wireless communication processor 407.

The user device 600 may include a motion sensor 408. The motion sensor 408 may detect features of motion (i.e., one or more movements) of the user device 600. For example, the motion sensor 408 may include an accelerometer to detect acceleration, a gyroscope to detect angular velocity, a geomagnetic sensor to detect direction, a geo-location sensor to detect location, etc., or a combination thereof to detect motion of the user device 600. In an embodiment, the motion sensor 408 may generate a detection signal that includes data representing the detected motion. For example, the motion sensor 408 may determine a number of distinct movements in a motion (e.g., from start of the series of movements to the stop, within a predetermined time interval, etc.), a number of physical shocks on the user device 600 (e.g., a jarring, hitting, etc., of the electronic device), a speed and/or acceleration of the motion (instantaneous and/or temporal), or other motion features. The detected motion features may be included in the generated detection signal. The detection signal may be transmitted, e.g., to the controller 410, whereby further processing may be performed based on data included in the detection signal. The motion sensor 408 can work in conjunction with a Global Positioning System (GPS) section 460. The information of the present position detected by the GPS section 460 is transmitted to the controller 410. An antenna 461 is connected to the GPS section 460 for receiving and transmitting signals to and from a GPS satellite.

The user device 600 may include a camera section 409, which includes a lens and shutter for capturing photographs of the surroundings around the user device 600. In an embodiment, the camera section 409 captures surroundings of an opposite side of the user device 600 from the user. The images of the captured photographs can be displayed on the display 420. A memory section saves the captured photographs. The memory section may reside within the camera section 109 or it may be part of the memory 450. The camera section 409 can be a separate feature attached to the user device 600 or it can be a built-in camera feature.

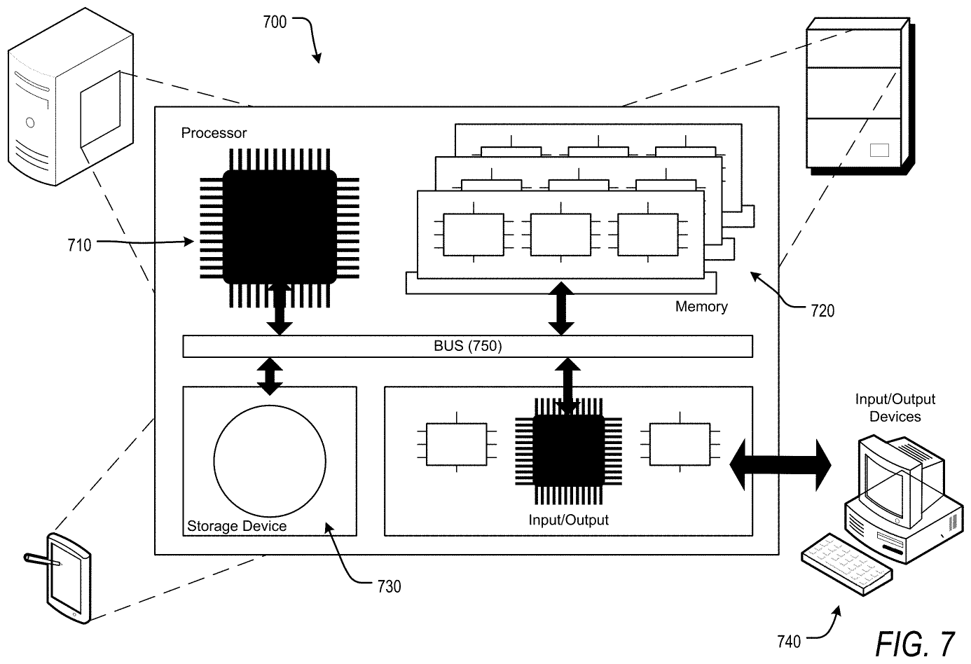

An example of a type of computer is shown in FIG. 7. The computer 700 can be used for the operations described in association with any of the computer-implement methods described previously, according to one implementation. For example, the computer 700 can be an example of devices 701, 702, 70n, 1001, or a server (such as device 850). The computer 700 includes processing circuitry, as discussed above. The device 850 may include other components not explicitly illustrated in FIG. 7 such as a CPU, GPU, frame buffer, etc. The processing circuitry includes one or more of the elements discussed next with reference to FIG. 7. In FIG. 7, the computer 700 includes a processor 710, a memory 720, a storage device 730, and an input/output device 740. Each of the components 710, 720, 730, and 740 are interconnected using a system bus 750. The processor 710 is capable of processing instructions for execution within the system 700. In one implementation, the processor 710 is a single-threaded processor. In another implementation, the processor 710 is a multi-threaded processor. The processor 710 is capable of processing instructions stored in the memory 720 or on the storage device 730 to display graphical information for a user interface on the input/output device 740.

The memory 720 stores information within the computer 700. In one implementation, the memory 720 is a computer-readable medium. In one implementation, the memory 720 is a volatile memory. In another implementation, the memory 720 is a non-volatile memory.

The storage device 730 is capable of providing mass storage for the system 700. In one implementation, the storage device 730 is a computer-readable medium. In various different implementations, the storage device 730 may be a floppy disk device, a hard disk device, an optical disk device, or a tape device.

The input/output device 740 provides input/output operations for the computer 700. In one implementation, the input/output device 740 includes a keyboard and/or pointing device. In another implementation, the input/output device 740 includes a display unit for displaying graphical user interfaces.

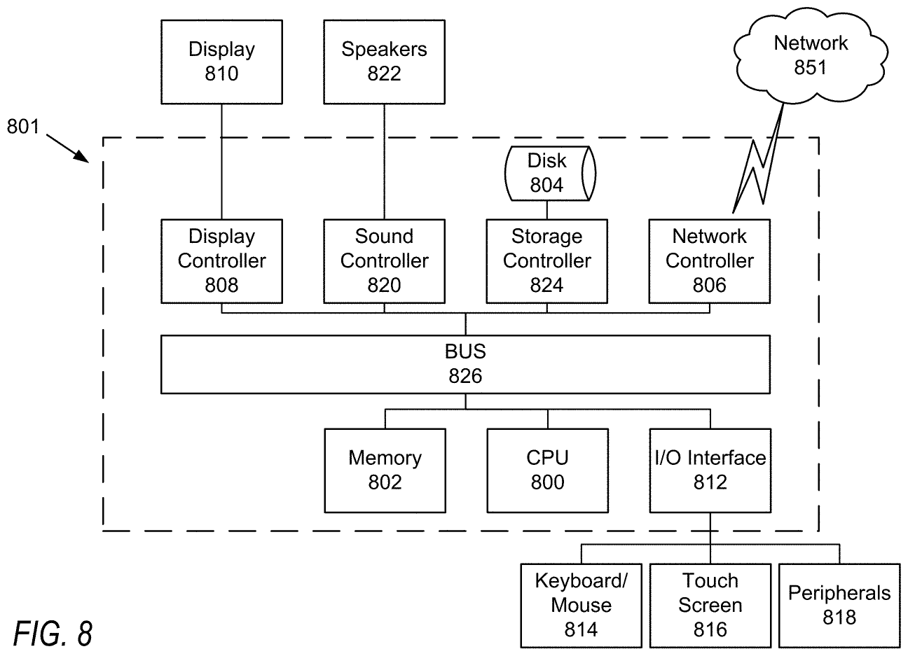

Next, a hardware description of a device 801 according to exemplary embodiments is described with reference to FIG. 8. In FIG. 8, the device 801, which can be the above described devices of FIG. 1, includes processing circuitry, as discussed above. The processing circuitry includes one or more of the elements discussed next with reference to FIG. 8. The device 801 may include other components not explicitly illustrated in FIG. 8 such as a CPU, GPU, frame buffer, etc. In FIG. 8, the device 801 the device includes a CPU 800 which performs the processes described above/below. The process data and instructions may be stored in memory 802. These processes and instructions may also be stored on a storage medium disk 804 such as a hard drive (HDD) or portable storage medium or may be stored remotely. Further, the claimed advancements are not limited by the form of the computer-readable media on which the instructions of the inventive process are stored. For example, the instructions may be stored on CDs, DVDs, in FLASH memory, RAM, ROM, PROM, EPROM, EEPROM, hard disk or any other information processing device with which the device communicates, such as a server or computer.

Further, the claimed advancements may be provided as a utility application, background daemon, or component of an operating system, or combination thereof, executing in conjunction with CPU 800 and an operating system such as Microsoft Windows, UNIX, Solaris, LINUX, Apple MAC-OS and other systems known to those skilled in the art.

The hardware elements in order to achieve the device may be realized by various circuitry elements, known to those skilled in the art. For example, CPU 800 may be a Xenon or Core processor from Intel of America or an Opteron processor from AMD of America, or may be other processor types that would be recognized by one of ordinary skill in the art. Alternatively, the CPU 800 may be implemented on an FPGA, ASIC, PLD or using discrete logic circuits, as one of ordinary skill in the art would recognize. Further, CPU 800 may be implemented as multiple processors cooperatively working in parallel to perform the instructions of the processes described above. CPU 800 can be an example of the CPU illustrated in each of the devices of FIG. 1.

The device 801 in FIG. 8 also includes a network controller 806, such as an Intel Ethernet PRO network interface card from Intel Corporation of America, for interfacing with the network 851 (also shown in FIG. 1), and to communicate with the other devices of FIG. 1. As can be appreciated, the network 851 can be a public network, such as the Internet, or a private network such as an LAN or WAN network, or any combination thereof and can also include PSTN or ISDN sub-networks. The network 851 can also be wired, such as an Ethernet network, or can be wireless such as a cellular network including EDGE, 3G, 4G and 5G wireless cellular systems. The wireless network can also be WiFi, Bluetooth, or any other wireless form of communication that is known.

The device further includes a display controller 808, such as a NVIDIA GeForce GTX or Quadro graphics adaptor from NVIDIA Corporation of America for interfacing with display 810, such as an LCD monitor. A general purpose I/O interface 812 interfaces with a keyboard and/or mouse 814 as well as a touch screen panel 816 on or separate from display 810. General purpose I/O interface also connects to a variety of peripherals 818 including printers and scanners.

A sound controller 820 is also provided in the device to interface with speakers/microphone 822 thereby providing sounds and/or music.

The general-purpose storage controller 824 connects the storage medium disk 804 with communication bus 826, which may be an ISA, EISA, VESA, PCI, or similar, for interconnecting all of the components of the device. A description of the general features and functionality of the display 810, keyboard and/or mouse 814, as well as the display controller 608, storage controller 824, network controller 806, sound controller 820, and general purpose I/O interface 812 is omitted herein for brevity as these features are known.

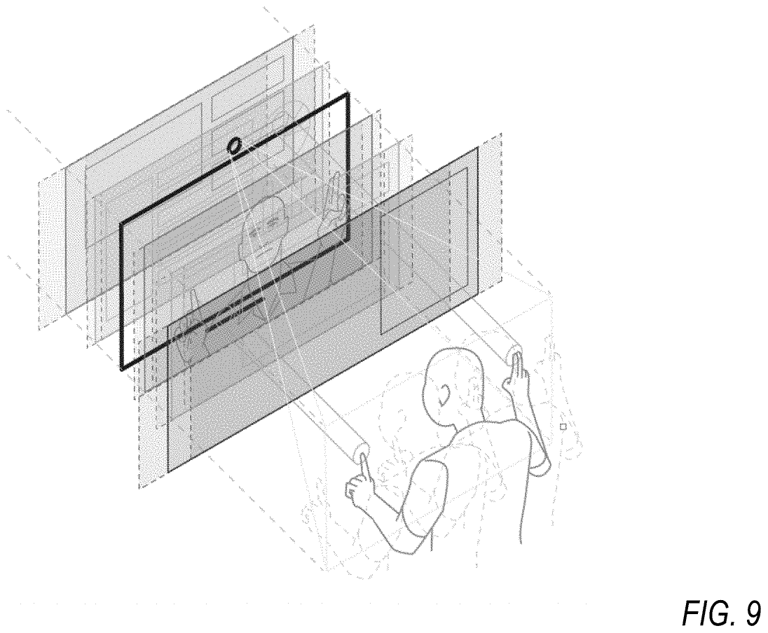

As shown in FIG. 9, in some embodiments, one or more of the disclosed functions and capabilities may be used to enable a volumetric composite of content-activated layers of Transparent Computing, content-agnostic layers of Transparent Computing and/or camera-captured layers of Transparent Computing placed visibly behind 2-dimensional or 3-dimensional content displayed on screens, placed in front of 2-dimensional or 3-dimensional content displayed on screens, placed inside of 3-dimensional content displayed on screens and/or placed virtually outside of the display of screens. Users can interact via Touchless Computing with any layer in a volumetric composite of layers of Transparent Computing wherein a user's gaze, gestures, movements, position, orientation, or other characteristics observed by a camera are used as the basis for selecting and interacting with objects in any layer in the volumetric composite of layers of Transparent Computing to execute processes on computing devices.

In some embodiments, one or more of the disclosed functions and capabilities may be used to enable users to see a volumetric composite of layers of Transparent Computing from a 360-degree Optical Lenticular Perspective wherein a user's gaze, gestures, movements, position, orientation, or other characteristics observed by cameras are a basis to calculate, derive and/or predict the 360-degree Optical Lenticular Perspective from which users see the volumetric composite of layers of Transparent Computing displayed on screens. Further, users can engage with a 3-dimensional virtual environment displayed on screens consisting of layers of Transparent Computing placed behind the 3-dimensional virtual environment displayed on screens, placed in front of a 3-dimensional virtual environment displayed on screens, and/or placed inside of the a 3-dimensional virtual environment displayed on screens wherein users can select and interact with objects in any layer of Transparent Computing to execute processes on computing devices while looking at the combination of the 3-dimensional virtual environment and the volumetric composite of layers of Transparent Computing from any angle of the 360-degree Optical Lenticular Perspective available to users.

Obviously, numerous modifications and variations are possible in light of the above teachings. It is therefore to be understood that within the scope of the appended claims, the embodiments may be practiced otherwise than as specifically described herein.

Embodiments of the present disclosure may also be as set forth in the following description.

An electronic device, including: processing circuitry, including an audio buffer, configured to receive data transmitted over a communication network during a voice call, access an audio buffer of the processing circuitry, analyze, in the audio buffer, audio data associated with the transmitted data, based on the analyzed audio data in the audio buffer, identify an audio reference patch that includes a unique identifier associated with an available area in which secondary digital content located at a remote device is insertable in displayed data that is being displayed by the processing circuitry during the voice call, after identifying the audio reference patch, retrieve the secondary digital content from the remote device based on the unique identifier, and after retrieving the secondary digital content from the remote device, overlay the secondary digital content into the displayed data during the voice call.

In an embodiment, the unique identifier is an acoustic fingerprint within the audio data, and the processing circuitry is further configured to identify the audio reference patch by analyzing a spectrogram of the audio data and comparing the spectrogram to a reference database of spectrograms corresponding to known acoustic fingerprints.

In an embodiment, the audio reference patch includes an acoustic flag within the audio data for audio processing detection, and the acoustic flag is followed by an acoustic identifier used to retrieve secondary digital content associated with the acoustic identifier.

In an embodiment, the audio reference patch includes an audio watermark that is followed by an acoustic identifier used to retrieve secondary digital content associated with the acoustic identifier.

In an embodiment, the processing circuitry is further configured to generate the audio watermark by at least one of a spread-spectrum method in Cepstrum domain, watermarking in a time domain, or time-spread echo methods.

In an embodiment, the electronic device is a smartphone and the data is programmed audio.

In an embodiment, the processing circuitry is further configured to receive the voice call from an external device, and the audio reference patch is embedded in the audio data after the voice call from the external device is received.

A method, including: receiving, by processing circuitry, data transmitted over a communication network during a voice call; accessing an audio buffer of the processing circuitry; analyzing, in the audio buffer of the processing circuitry, audio data associated with the transmitted data; based on the analyzed audio data in the audio buffer, identifying an audio reference patch that includes a unique identifier associated with an available area in which secondary digital content located at a remote device is insertable in displayed data that is being displayed by the processing circuitry during the voice call; after identifying the audio reference patch, retrieving the secondary digital content from the remote device based on the unique identifier; and after retrieving the secondary digital content from the remote device, overlaying the secondary digital content into the displayed data during the voice call.

In an embodiment, the unique identifier is an acoustic fingerprint within the audio data, and the identifying of the audio reference patch further comprises analyzing a spectrogram of the audio data and comparing the spectrogram to a reference database of spectrograms corresponding to known acoustic fingerprints.

In an embodiment, the audio reference patch includes an acoustic flag within the audio data for audio processing detection, wherein the acoustic flag is followed by an acoustic identifier used to retrieve secondary digital content associated with the acoustic identifier.

In an embodiment, the audio reference patch includes an audio watermark that is followed by an acoustic identifier used to retrieve secondary digital content associated with the acoustic identifier.

In an embodiment, the method further comprises generating the audio watermark by at least one of a spread-spectrum method in Cepstrum domain, watermarking in a time domain, or time-spread echo methods.

In an embodiment, the processing circuitry is included in a smartphone, and the data is programmed audio.

In an embodiment, the method further comprises receiving the voice call from an external device, wherein the audio reference patch is embedded in the audio data after the voice call from the external device is received.

A non-transitory computer-readable storage medium storing computer-readable instructions that, when executed by a computer, cause the computer to perform a method, including: receiving, by processing circuitry, data transmitted over a communication network during a voice call; accessing an audio buffer of the processing circuitry; analyzing, in the audio buffer of the processing circuitry, audio data associated with the transmitted data; based on the analyzed audio data in the audio buffer, identifying an audio reference patch that includes a unique identifier associated with an available area in which secondary digital content located at a remote device is insertable in displayed data that is being displayed by the processing circuitry during the voice call; after identifying the audio reference patch, retrieving the secondary digital content from the remote device based on the unique identifier; and after retrieving the secondary digital content from the remote device, overlaying the secondary digital content into the displayed data during the voice call.

In an embodiment, the unique identifier is an acoustic fingerprint within the audio data, and the identifying of the audio reference patch further comprises analyzing a spectrogram of the audio data and comparing the spectrogram to a reference database of spectrograms corresponding to known acoustic fingerprints.

In an embodiment, the audio reference patch includes an acoustic flag within the audio data for audio processing detection, wherein the acoustic flag is followed by an acoustic identifier used to retrieve secondary digital content associated with the acoustic identifier.

In an embodiment, the audio reference patch includes an audio watermark that is followed by an acoustic identifier used to retrieve secondary digital content associated with the acoustic identifier.

In an embodiment, the method further comprises generating the audio watermark by at least one of a spread-spectrum method in Cepstrum domain, watermarking in a time domain, or time-spread echo methods.

In an embodiment, the method further comprises receiving the voice call from an external device and the audio reference patch is embedded in the audio data after the voice call from the external device is received.

While this specification contains many specific implementation details, these should not be construed as limitations on the scope of what may be claimed, but rather as descriptions of features that may be specific to particular embodiments.

Certain features that are described in this specification in the context of separate embodiments can also be implemented in combination in a single embodiment. Conversely, various features that are described in the context of a single embodiment can also be implemented in multiple embodiments separately or in any suitable sub-combination. Moreover, although features may be described above as acting in certain combinations and even initially claimed as such, one or more features from a claimed combination can in some cases be excised from the combination, and the claimed combination may be directed to a sub-combination or variation of a sub-combination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system modules and components in the embodiments described above should not be understood as requiring such separation in all embodiments, and it should be understood that the described program components and systems can generally be integrated together in a single software product or packaged into multiple software products.

Particular embodiments of the subject matter have been described. Other embodiments are within the scope of the following claims. For example, the actions recited in the claims can be performed in a different order and still achieve desirable results. As one example, the processes depicted in the accompanying figures do not necessarily require the particular order shown, or sequential order, to achieve desirable results. In some cases, multitasking and parallel processing may be advantageous.

Thus, the foregoing discussion discloses and describes merely exemplary embodiments. As will be understood by those skilled in the art, the present disclosure may be embodied in other specific forms without departing from the spirit or essential characteristics thereof. Accordingly, the disclosure is intended to be illustrative, but not limiting of the scope of thereof, as well as other claims. The disclosure, including any readily discernible variants of the teachings herein, defines, in part, the scope of the foregoing claim terminology such that no inventive subject matter is dedicated to the public.

1. An electronic device, comprising:
processing circuitry, including an audio buffer, configured to
receive data transmitted over a communication network during a voice call,
access an audio buffer of the processing circuitry,
analyze, in the audio buffer, audio data associated with the transmitted data,
based on the analyzed audio data in the audio buffer, identify an audio reference patch that includes a unique identifier associated with an available area in which secondary digital content located at a remote device is insertable in displayed data that is being displayed by the processing circuitry during the voice call,
after identifying the audio reference patch, retrieve the secondary digital content from the remote device based on the unique identifier, and
after retrieving the secondary digital content from the remote device, overlay the secondary digital content into the displayed data during the voice call.

2. The electronic device of claim 1, wherein
the unique identifier is an acoustic fingerprint within the audio data, and
the processing circuitry is further configured to identify the audio reference patch by analyzing a spectrogram of the audio data and comparing the spectrogram to a reference database of spectrograms corresponding to known acoustic fingerprints.

3. The electronic device of claim 1, wherein
the audio reference patch includes an acoustic flag within the audio data for audio processing detection, and
the acoustic flag is followed by an acoustic identifier used to retrieve secondary digital content associated with the acoustic identifier.

4. The electronic device of claim 1, wherein the audio reference patch includes an audio watermark that is followed by an acoustic identifier used to retrieve secondary digital content associated with the acoustic identifier.

5. The electronic device of claim 4, wherein the processing circuitry is further configured to generate the audio watermark by at least one of a spread-spectrum method in Cepstrum domain, watermarking in a time domain, or time-spread echo methods.

6. The electronic device of claim 1, wherein the electronic device is a smartphone and the data is programmed audio.

7. The electronic device of claim 1, wherein
the processing circuitry is further configured to receive the voice call from an external device, and
the audio reference patch is embedded in the audio data after the voice call from the external device is received.

8. A method, comprising:
receiving, by processing circuitry, data transmitted over a communication network during a voice call;
accessing an audio buffer of the processing circuitry;
analyzing, in the audio buffer of the processing circuitry, audio data associated with the transmitted data;
based on the analyzed audio data in the audio buffer, identifying an audio reference patch that includes a unique identifier associated with an available area in which secondary digital content located at a remote device is insertable in displayed data that is being displayed by the processing circuitry during the voice call;
after identifying the audio reference patch, retrieving the secondary digital content from the remote device based on the unique identifier; and
after retrieving the secondary digital content from the remote device, overlaying the secondary digital content into the displayed data during the voice call.

9. The method of claim 8, wherein
the unique identifier is an acoustic fingerprint within the audio data, and
the identifying of the audio reference patch further comprises analyzing a spectrogram of the audio data and comparing the spectrogram to a reference database of spectrograms corresponding to known acoustic fingerprints.

10. The method of claim 8, wherein the audio reference patch includes an acoustic flag within the audio data for audio processing detection, wherein the acoustic flag is followed by an acoustic identifier used to retrieve secondary digital content associated with the acoustic identifier.

11. The method of claim 8, wherein the audio reference patch includes an audio watermark that is followed by an acoustic identifier used to retrieve secondary digital content associated with the acoustic identifier.

12. The method of claim 11, further comprising generating the audio watermark by at least one of a spread-spectrum method in Cepstrum domain, watermarking in a time domain, or time-spread echo methods.

13. The method of claim 8, wherein the processing circuitry is included in a smartphone, and the data is programmed audio.

14. The method of claim 8, further comprising receiving the voice call from an external device, wherein the audio reference patch is embedded in the audio data after the voice call from the external device is received.

15. A non-transitory computer-readable storage medium storing computer-readable instructions that, when executed by a computer, cause the computer to perform a method, comprising:
receiving, by processing circuitry, data transmitted over a communication network during a voice call;
accessing an audio buffer of the processing circuitry;
analyzing, in the audio buffer of the processing circuitry, audio data associated with the transmitted data;
based on the analyzed audio data in the audio buffer, identifying an audio reference patch that includes a unique identifier associated with an available area in which secondary digital content located at a remote device is insertable in displayed data that is being displayed by the processing circuitry during the voice call;
after identifying the audio reference patch, retrieving the secondary digital content from the remote device based on the unique identifier; and
after retrieving the secondary digital content from the remote device, overlaying the secondary digital content into the displayed data during the voice call.

16. The non-transitory computer-readable storage medium according to claim 15, wherein
the unique identifier is an acoustic fingerprint within the audio data, and
the identifying of the audio reference patch further comprises analyzing a spectrogram of the audio data and comparing the spectrogram to a reference database of spectrograms corresponding to known acoustic fingerprints.

17. The non-transitory computer-readable storage medium according to claim 15, wherein the audio reference patch includes an acoustic flag within the audio data for audio processing detection, wherein the acoustic flag is followed by an acoustic identifier used to retrieve secondary digital content associated with the acoustic identifier.

18. The non-transitory computer-readable storage medium according to claim 15, wherein the audio reference patch includes an audio watermark that is followed by an acoustic identifier used to retrieve secondary digital content associated with the acoustic identifier.

19. The non-transitory computer-readable storage medium according to claim 18, wherein the method further comprises generating the audio watermark by at least one of a spread-spectrum method in Cepstrum domain, watermarking in a time domain, or time-spread echo methods.

20. The non-transitory computer-readable storage medium according to claim 15, wherein the method further comprises receiving the voice call from an external device and the audio reference patch is embedded in the audio data after the voice call from the external device is received.
